(19) United States
(12) Patent Application Publication
(10) Pub. No.: US 2016/0376691 A1
(43) Pub. Date: Dec. 29, 2016

(54) MULTILAYERED THERMAL AND ENVIRONMENTAL BARRIER COATING (EBC) FOR HIGH TEMPERATURE APPLICATIONS AND METHOD THEREOF

(71) Applicant: University of Virginia Patent Foundation, Charlottesville, VA (US)

(72) Inventors: Haydn N.G. Wadley, Keswick, VA (US); Bradley Thomas Richards, Charlottesville, VA (US)

(21) Appl. No.: 15/166,856

(22) Filed: May 27, 2016

Related U.S. Application Data
(60) Provisional application No. 62/166,789, filed on May 27, 2015.

(51) Int. Cl. C23C 4/134; C09D 1/00; C09D 5/18; C09D 183/04; C23C 4/11; C23C 4/10

(52) U.S. Cl. CPC C23C 4/134; C23C 4/11; C23C 4/10; C09D 5/18; C09D 183/04; C09D 1/00

(57) ABSTRACT

An air plasma method for the deposition of an advanced EBC coating system, and an EBC coating system.

### FIELD

Multilayer thermal and environment barrier coating (EBC) for high temperature applications such as for gas turbine engines and related methods thereof.

### BACKGROUND

The maturation of thermal protection concepts for metallic components in the most advanced gas turbine engines has stimulated efforts to develop turbine components from ceramic materials with much higher maximum use temperatures. The focus has been directed upon more damage tolerant fiber reinforced ceramic matrix composites (CMCs) with weak fiber/matrix interfaces.

FIG. 1 shows the past evolution of turbine inlet gas flow and material temperatures for the most advanced engines and anticipates the needs and our view of the most promising candidate materials and thermal management strategies of the near future. The most promising CMC's are based either upon (i) woven fabrics or [0°/90° ] ply lay-ups of either aluminum oxide (Nextel 720) fibers and tape cast alumina matrices or (ii) boron nitride coated SiC fibers (such as Hi-Nicalon S and Sylramic fibers) and SiC or more fiber protective matrices. While the oxide CMC systems are chemically inert in oxidizing environments, the current fibers have low creep rupture strengths at engine operating temperatures and so the most highly loaded components in future engines are likely to utilize SiC CMC systems.

Unfortunately, silicon containing ceramics react with oxygen and water vapor in combustion environments to form SiO₂ scales, and these then react with water vapor to form gaseous silicon hydroxide by the reactions:

SiO₂(s)+2H₂O(g)=Si(OH)₄(g)

The rate of SiC volatilization depends upon the temperature, the incident water vapor flux (engine pressure), and the effectiveness with which the silicon hydroxide reactions occur, as shown in FIG. 2. SiC recession rates significantly greater than 1 μm/hr can occur at engine gas temperatures in the 1300-1350° C. temperature range where pressures of 5-20 atmospheres (or higher) exist (depending upon the engine's altitude of operation and overall pressure ratio). Since engine components are normally expected to survive for thousands of hours of operation, these composite components must be coated by materials that impede the diffusion of oxygen and water vapor to the composite surface, thereby inhibiting reactions. The development of these environmental barrier coatings (EBCs) is likely to pace the future use of silicon-based CMC's in the hot sections of military engines until the discovery and development of other (less vulnerable) ceramic systems (such as higher creep strength fibers such as oxide fibers) shown in FIG. 1.

### SUMMARY

The presently described subject matter is directed to an air plasma method for the deposition of an advanced EBC coating system.

The presently described subject matter is directed to an air plasma method for the deposition of an advanced EBC coating system comprising or consisting of applying a silicone bond coat to a SiC substrate; exposing the silicone bond coat to oxygen to form a proactive SiO₂ thermally grown oxide (TGO) layer to avoid decomposition of the SiC substrate to SiO₂ and gaseous CO; applying a layer of mullite over the silicon bond coat to impede diffusion of oxygen to the silicon bond coat; and applying a ytterbium disilicate topcoat over the layer of mullite, the ytterbium disilicate having a very low silica volatility and protecting the layer of mullite and silicon layer from volatilization by water vapor.

The presently described subject matter is directed to an air plasma method for the deposition of an advanced EBC coating system comprising or consisting of applying a silicone bond coat to a SiC substrate; exposing the silicone bond coat to oxygen to form a proactive SiO₂ thermally grown oxide (TGO) layer to avoid decomposition of the SiC substrate to SiO₂ and gaseous CO; applying a layer of mullite over the silicon bond coat to impede diffusion of oxygen to the silicon bond coat; and applying a ytterbium disilicate topcoat over the layer of mullite, the ytterbium disilicate having a very low silica volatility and protecting the layer of mullite and silicon layer from volatilization by water vapor, wherein the silicon bond coat is applied directly to the SiC substrate.

The presently described subject matter is directed to an air plasma method for the deposition of an advanced EBC coating system comprising or consisting of applying a silicone bond coat to a SiC substrate; exposing the silicone bond coat to oxygen to form a proactive SiO₂ thermally grown oxide (TGO) layer to avoid decomposition of the SiC substrate to SiO₂ and gaseous CO; applying a layer of mullite over the silicon bond coat to impede diffusion of oxygen to the silicon bond coat; and applying a ytterbium disilicate topcoat over the layer of mullite, the ytterbium disilicate having a very low silica volatility and protecting the layer of mullite and silicon layer from volatilization by water vapor, wherein the ytterbium disilicate topcoat is applied directly to the silicon bond coat.

The presently described subject matter is directed to an air plasma method for the deposition of an advanced EBC coating system comprising or consisting of applying a silicone bond coat to a SiC substrate; exposing the silicone bond coat to oxygen to form a proactive SiO₂ thermally grown oxide (TGO) layer to avoid decomposition of the SiC substrate to SiO₂ and gaseous CO; applying a layer of mullite over the silicon bond coat to impede diffusion of oxygen to the silicon bond coat; and applying a ytterbium disilicate topcoat over the layer of mullite, the ytterbium disilicate having a very low silica volatility and protecting the layer of mullite and silicon layer from volatilization by water vapor, wherein the ytterbium disilcate topcoat is applied as a two layer coating system.

The presently described subject matter is directed to an air plasma method for the deposition of an advanced EBC coating system comprising or consisting of applying a silicone bond coat to a SiC substrate; exposing the silicone bond coat to oxygen to form a proactive SiO₂ thermally grown oxide (TGO) layer to avoid decomposition of the SiC substrate to SiO₂ and gaseous CO; applying a layer of mullite over the silicon bond coat to impede diffusion of oxygen to the silicon bond coat; and applying a ytterbium disilicate topcoat over the layer of mullite, the ytterbium disilicate having a very low silica volatility and protecting the layer of mullite and silicon layer from volatilization by water vapor, wherein the ytterbium disilcate topcoat is applied as a two layer coating system, wherein a first layer of the two layer coating system is deposited on the silicone bond coat at 1200° C. in a reducing (Ar/H2) atmosphere.

The presently described subject matter is directed to an air plasma method for the deposition of an advanced EBC coating system comprising or consisting of applying a silicone bond coat to a SiC substrate; exposing the silicone bond coat to oxygen to form a proactive SiO₂ thermally grown oxide (TGO) layer to avoid decomposition of the SiC substrate to SiO₂ and gaseous CO; applying a layer of mullite over the silicon bond coat to impede diffusion of oxygen to the silicon bond coat; and applying a ytterbium disilicate topcoat over the layer of mullite, the ytterbium disilicate having a very low silica volatility and protecting the layer of mullite and silicon layer from volatilization by water vapor, wherein the ytterbium disilcate topcoat is applied as a two layer coating system, wherein the first layer is 50 μm thick.

The presently described subject matter is directed to an air plasma method for the deposition of an advanced EBC coating system comprising or consisting of applying a silicone bond coat to a SiC substrate; exposing the silicone bond coat to oxygen to form a proactive SiO₂ thermally grown oxide (TGO) layer to avoid decomposition of the SiC substrate to SiO₂ and gaseous CO; applying a layer of mullite over the silicon bond coat to impede diffusion of oxygen to the silicon bond coat; and applying a ytterbium disilicate topcoat over the layer of mullite, the ytterbium disilicate having a very low silica volatility and protecting the layer of mullite and silicon layer from volatilization by water vapor, wherein the ytterbium disilcate topcoat is applied as a two layer coating system, wherein the first layer has a porosity of about 5%.

The presently described subject matter is directed to an air plasma method for the deposition of an advanced EBC coating system comprising or consisting of applying a silicone bond coat to a SiC substrate; exposing the silicone bond coat to oxygen to form a proactive SiO₂ thermally grown oxide (TGO) layer to avoid decomposition of the SiC substrate to SiO₂ and gaseous CO; applying a layer of mullite over the silicon bond coat to impede diffusion of oxygen to the silicon bond coat; and applying a ytterbium disilicate topcoat over the layer of mullite, the ytterbium disilicate having a very low silica volatility and protecting the layer of mullite and silicon layer from volatilization by water vapor, wherein the ytterbium disilcate topcoat is applied as a two layer coating system, wherein a second layer of the two layer coating system is deposited on the first layer at 1200° C., without a protective reducing gas atmosphere.

The presently described subject matter is directed to an air plasma method for the deposition of an advanced EBC coating system comprising or consisting of applying a silicone bond coat to a SiC substrate; exposing the silicone bond coat to oxygen to form a proactive SiO₂ thermally grown oxide (TGO) layer to avoid decomposition of the SiC substrate to SiO₂ and gaseous CO; applying a layer of mullite over the silicon bond coat to impede diffusion of oxygen to the silicon bond coat; and applying a ytterbium disilicate topcoat over the layer of mullite, the ytterbium disilicate having a very low silica volatility and protecting the layer of mullite and silicon layer from volatilization by water vapor, wherein a surface of the SiC substrate is roughened before applying the silicone bond coat to the surface of the SiC substrate

The presently described subject matter is directed to an EBC system comprising or consisting of a SiC substrate; a silicon bond coat applied directly to the SiC substrate; a proactive SiO₂ thermally grown oxide (TGO) layer applied over the silicone bond coat; a layer of mullite applied over the silicon bond coat; and a ytterbium disilicate topcoat applied over the layer of mullite.

The presently described subject matter is directed to an EBC system comprising or consisting of a SiC substrate; a silicon bond coat applied directly to the SiC substrate; a proactive SiO₂ thermally grown oxide (TGO) layer applied over the silicone bond coat; a layer of mullite applied over the silicon bond coat; and a ytterbium disilicate topcoat applied over the layer of mullite, wherein the silicon bond coat is applied directly to the SiC substrate.

The presently described subject matter is directed to an EBC system comprising or consisting of a SiC substrate; a silicon bond coat applied directly to the SiC substrate; a proactive SiO₂ thermally grown oxide (TGO) layer applied over the silicone bond coat; a layer of mullite applied over the silicon bond coat; and a ytterbium disilicate topcoat applied over the layer of mullite, wherein the ytterbium disilicate topcoat is applied directly to the silicon bond coat.

The presently described subject matter is directed to an EBC system comprising or consisting of a SiC substrate; a silicon bond coat applied directly to the SiC substrate; a proactive SiO₂ thermally grown oxide (TGO) layer applied over the silicone bond coat; a layer of mullite applied over the silicon bond coat; and a ytterbium disilicate topcoat applied over the layer of mullite, wherein the ytterbium disilcate topcoat is applied as a two layer coating system.

The presently described subject matter is directed to an EBC system comprising or consisting of a SiC substrate; a silicon bond coat applied directly to the SiC substrate; a proactive SiO₂ thermally grown oxide (TGO) layer applied over the silicone bond coat; a layer of mullite applied over the silicon bond coat; and a ytterbium disilicate topcoat applied over the layer of mullite, wherein the ytterbium disilcate topcoat is applied as a two layer coating system, and wherein a first layer of the two layer coating system is deposited on the silicone bond coat at 1200° C. in a reducing (Ar/H2) atmosphere.

The presently described subject matter is directed to an EBC system comprising or consisting of a SiC substrate; a silicon bond coat applied directly to the SiC substrate; a proactive SiO₂ thermally grown oxide (TGO) layer applied over the silicone bond coat; a layer of mullite applied over the silicon bond coat; and a ytterbium disilicate topcoat applied over the layer of mullite, wherein the ytterbium disilcate topcoat is applied as a two layer coating system, wherein a first layer of the two layer coating system is deposited on the silicone bond coat at 1200° C. in a reducing (Ar/H2) atmosphere, and wherein the first layer is 50 μm thick.

The presently described subject matter is directed to an EBC system comprising or consisting of a SiC substrate; a silicon bond coat applied directly to the SiC substrate; a proactive SiO₂ thermally grown oxide (TGO) layer applied over the silicone bond coat; a layer of mullite applied over the silicon bond coat; and a ytterbium disilicate topcoat applied over the layer of mullite, wherein the ytterbium disilcate topcoat is applied as a two layer coating system, and wherein a first layer of the two layer coating system is deposited on the silicone bond coat at 1200° C. in a reducing (Ar/H2) atmosphere, and wherein the first layer has a porosity of about 5%.

The presently described subject matter is directed to an EBC system comprising or consisting of a SiC substrate; a silicon bond coat applied directly to the SiC substrate; a proactive SiO₂ thermally grown oxide (TGO) layer applied over the silicone bond coat; a layer of mullite applied over the silicon bond coat; and a ytterbium disilicate topcoat applied over the layer of mullite, wherein the ytterbium disilcate topcoat is applied as a two layer coating system, wherein a first layer of the two layer coating system is deposited on the silicone bond coat at 1200° C. in a reducing (Ar/H2) atmosphere, and wherein a second layer of the two layer coating system is deposited on the first layer at 1200° C., without a protective reducing gas atmosphere.

The presently described subject matter is directed to an EBC system comprising or consisting of a SiC substrate; a silicon bond coat applied directly to the SiC substrate; a proactive SiO₂ thermally grown oxide (TGO) layer applied over the silicone bond coat; a layer of mullite applied over the silicon bond coat; and a ytterbium disilicate topcoat applied over the layer of mullite, wherein a surface of the SiC substrate is roughened before applying the silicone bond coat to the surface of the SiC substrate.

### BRIEF DESCRIPTION OF DRAWINGS

FIG. 1 is a graphical illustration of the past and (predicted) future evolution of propulsion materials, coatings, cooling concepts and turbine inlet gas temperatures verses the year of entry.

FIG. 2 is a graphical illustration of a summary of SiC recession rate data at 1300-1350° C. in water vapor rich environments.

FIG. 3 is a schematic illustration of an advanced EBC system deposited on a SiC textile/SiC matrix composite.

FIG. 4 is a graphical illustration of the specific weight change measurements for a variety of candidate EBC materials.

FIGS. 5A-5D is a diagram of the APS system for EBC deposition.

FIG. 6A is a visual illustration of the as-deposited tri-layer EBC system deposited on a monolithic α-SiC substrate with Ytterbium monosilicate top coat deposited on mullite using silicon bond coated substrate.

FIG. 6B is a visual illustration of the as-deposited tri-layer EBC system deposited on a monolithic α-SiC substrate with ytterbium disilicate top coat deposited on mullite using silicon bond coated substrate.

FIG. 7A is a cross-sectional BSE micrograph of a delaminated YbMS top coat EBC after 250, 1-hour steam cycles at 1316° C. with the cross-section at 1 mm. Note the oxide layer that has formed on the bifurcated crack faces in the silicon bond coat.

FIG. 7B is a cross-sectional BSE micrograph of a delaminated YbMS top coat EBC after 250, 1-hour steam cycles at 1316° C. with the cross-section at 3 mm. Note the oxide layer that has formed on the bifurcated crack faces in the silicon bond coat.

FIG. 8 is a table showing the physical and mechanical properties of the YbMS tri-layer EBC system and layer residual stresses after cooling from 1300° C.

FIGS. 9A-9D are illustrations of the failure mode of the YbMS topcoat EBC system during steam cycling.

FIG. 10A is a BSE mode SEM image of the bi-layer YbDS/Si EBC.

FIG. 10B is a BSE mode SEM image of the bi-layer YbDS/Si EBC. at a higher magnification view of the Si-YbDS interface showing Yb₂SiO₅ precipitates.

FIGS. 11A-11F are cross-sectional images of the bi-layer YbDS/Si EBC during steam cycling. Note the beginning of SiO volatilization after 2,000 hr of steam exposure at 1316° C.

FIG. 12A is a micrograph of the TGO layer (left) after 2,000 steam cycles.

FIG. 12B is a graphical illustration showing the dependence of the TGO thickness upon exposure time at 1316° C. in steam.

FIG. 13 is a table showing a summary of the residual stress in the layers of the YbDS/Si EBC system.

FIG. 14 is a graphical illustration showing creep strain verses time for a flexural test of YbDS conducted at a stress of 15.8 MPa at test temperatures of 800° to 900° C.

FIG. 15 is a graphical illustration showing the reaction product thickness formed during exposure of ytterbium silicate coatings to CMAS deposits at 1300° C.

FIG. 16 is a BSE image of the YbDS coating exposed to CMAS at 1300° C. for 100 h.

FIG. 17 is a schematic illustration of the CMAS reaction with an APS deposited YbDS coating containing silica-depleted regions which are more rapidly attacked.

FIG. 18 is the 1500° C. isothermal section of the HfO₂—SiO₂—YbO_{1.5} ternary system.

FIG. 19 is a table showing the thermophysical properties of creep resistant EBC materials and homologous temperature (T/Tₘ) at 1316° C.

FIG. 20 is a schematic illustration showing the baseline EBC system.

FIG. 21 is a schematic illustration of showing the morphologically evolved creep resistant structure (gadolinia doping of the TBC is not shown).

FIG. 22 is a schematic illustration showing an electron beam directed vapor deposition tool showing co-evaporation of two source materials with assisted plasma.

FIG. 23 is a schematic illustration of the APS gun with two internal powder injectors. The approximate particle velocities and plasma temperatures are labeled.

FIG. 24 is a schematic illustration of the steam cycling furnace for conducting water vapor erosion studies on EBC systems.

FIG. 25 is a table showing the key milestones and schedule for completion.

FIG. 26A is a graphical illustration of the past and (predicted) future evolution of propulsion materials, coatings, cooling concepts and turbine inlet gas temperatures verses the year of entry.

FIG. 26B is a schematic view showing the apparatus for applying the coating.

FIG. 26C is a schematic view showing the layer structure or arrangement of the coating.

FIG. 26D is a schematic view of the steam volatilization of silica.

FIG. 27 is a table of the candidate EBD systems.

FIG. 28A is a graph showing the steam erosion rate of EBC top coat materials.

FIG. 28B is a graphical illustration showing the steam erosion rate of EBC top coat materials.

FIG. 28C is a schematic view showing the layer structure or arrangement of Yb disilicate.

FIG. 29 is a schematic view showing the layer structure or arrangement of the calculated thermal stress of Yb disilicate.

FIG. 30 is a table of the properties of various coating materials.

FIGS. 31A-31D are images showing the cracking of the “as-deposited” Yb monosilicate topcoat.

FIGS. 32A-32D are images showing the stabilization annealed Yb monosilicate topcoat.

FIG. 33A is a graphical illustration showing the compositional fluctuation in Yb monosilicate and Mullite.

FIG. 33B is a graphical illustration showing the compositional fluctuation in Yb monosilicate and Mullite.

FIGS. 34A-34D are images of the annealed Yb disilicate layer structure.

FIG. 35A is an image showing microcracking of the Yb monosilicate structure.

FIG. 35B is a graphical illustration of temperature verses mol %.

FIG. 35C is a graphical illustration of partial pressure verses temperature.

FIGS. 36A-36D are images showing the phase precipitation in the Yb monosilicate coating.

FIGS. 37A-37B are images showing the SAED for precipitated particles.

FIG. 37C is an image showing the [210] zone.

FIG. 37D is a table showing the precipitated particles and background matrix of the elements (at. %).

FIG. 38A is a schematic illustration showing the deposition system for applying coatings.

FIG. 38B is a schematic illustration showing the torch motion trajectory.

FIG. 39 is an image showing the actual deposition system in operation.

FIG. 40 is an image showing loading or retrieving sample from the deposition system shown in FIG. 39.

FIGS. 41A and 41B are images showing the “as-deposited” Yb monosilicate coating and annealed Yb monosilicate coating.

FIG. 42 is a detail schematic illustration of the deposition system shown in FIG. 39.

FIG. 43 is a table of the Yb monosilicate deposition matrix.

FIGS. 44A-44D are images of the Yb monosilicate coating under plasma current variation.

FIGS. 45A-45D are images of the Yb monosilicate coating under a hydrogen study.

FIG. 46 is a graphical illustration of a Yb:Si ratio.

FIG. 47A is a graphical illustration of a steam cycling furnace.

FIG. 47B is a graphical illustration of a steam cycling furnace.

FIG. 48 is a graphical illustration of failure probability (%) verses number of cycles of tested EMCs.

FIG. 49A is a detailed image of the TGO layer of the coating.

FIG. 49B is a detailed image of the layers of the coating.

FIG. 49C is a detailed image showing the mud-crack.

FIGS. 50A-50D are detailed images showing the structure of the coating.

FIG. 51A is are detailed images showing near edge, 25 mm, 5 mm, and 10 mm.

FIG. 51B is a graphical illustration of a Raman Spectra of Silicon/Mullite interface.

FIG. 52 is a schematic illustration of the change of structure upon cooling.

FIG. 53 is a graphical illustration of ERR (N/m) verses % Conversion Si.

FIG. 54 is a graphical illustration of ERR (N/m) verses % Conversion Si.

FIG. 55 is a graphical illustration of ERR (N/m) verses % Conversion Si.

FIG. 56A is are images of “mud cracking” in the annealed coating.

FIG. 56B is are images of steam cycling early behavior of the coating.

FIG. 57A are images of steam cycling before failure of the coating.

FIG. 57B are images of failure of coating.

FIGS. 58A-58C are detailed images showing mud cracks and voids in the coating.

FIGS. 59A-59D are detailed images showing the structure of the coating.

FIG. 60 is an image showing airplane engine operating in a difficult sand (Si) environment.

FIGS. 61A-61F are detailed images showing the structure of the Yb monosilicate effect of reaction time.

FIGS. 62A and 62B are detailed images showing the effect of reaction time.

FIG. 63 is a graphical illustration showing the reaction layer thickness verses time.

FIGS. 64A and 64B are graphical illustration showing the composition profile for a baseline sample.

FIG. 65 is an image and table showing CMAS reaction and element (at. %) and reaction product.

FIGS. 66A-66C are images showing TEM specimens by FIB lift-out.

FIGS. 67A-67D are images and table showing SAED patterns for the reaction product.

FIGS. 68A and 68B are detailed images showing the CMAS reaction interface.

FIGS. 69A-69D are detailed images showing elemental mapping.

FIG. 70 is a detailed image showing layered image for elemental mapping.

FIGS. 71A-71D are detailed images showing the effect of current.

FIGS. 72A-72D are detailed images showing the effect of hydrogen flow.

FIG. 73 is a graphical illustration showing the effect of deposition conditions on CMAS reaction rate.

FIGS. 74A-74C are detailed images and table showing EDS.

FIG. 75 is a table of APS parameters for Yb disilicate coatings.

FIGS. 76A and 76B are detailed images showing the baseline Yb disilicate sample.

FIGS. 76C-76E is a detailed image and table showing the baseline Yb disilicate sample.

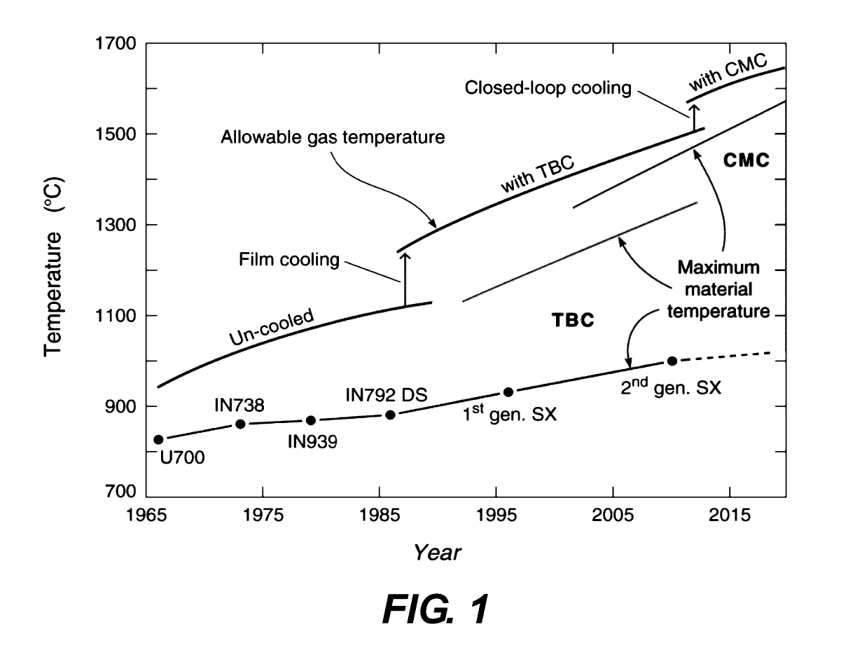

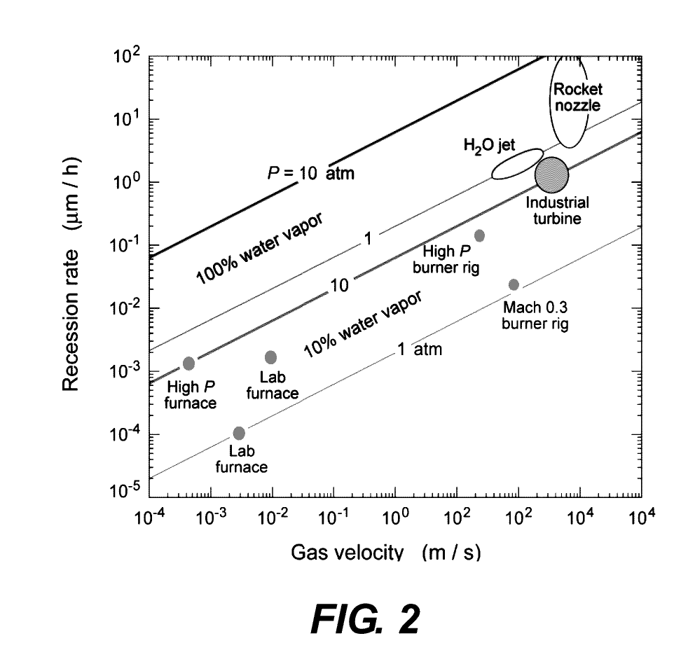

### DETAILED DESCRIPTION

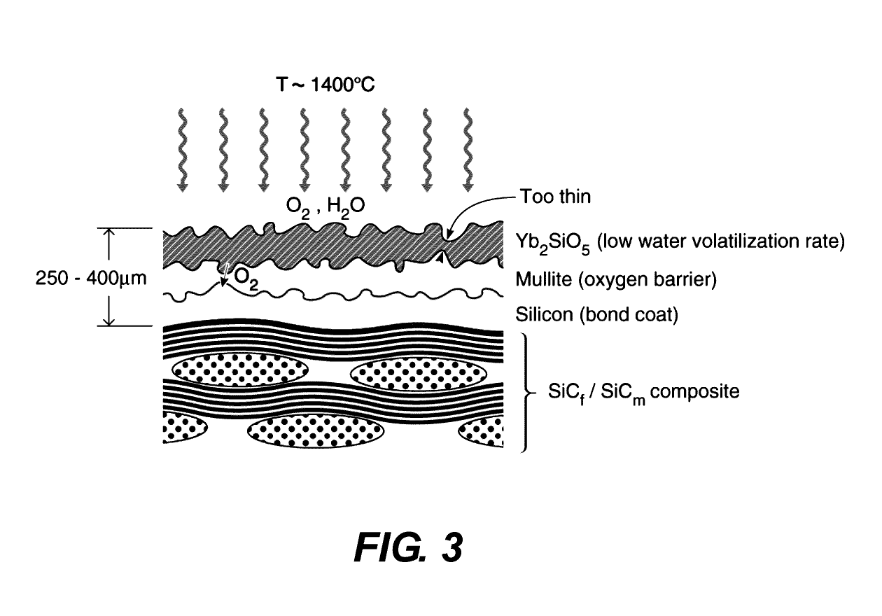

An air plasma method for the deposition of an advanced EBC coating system, is shown in FIG. 3. The steam cycling response for the EBC coating system is investigated below.

The EBC system consists of a silicon bond coat applied directly to a SiC substrate. The purpose of this layer is to provide prime reliant protection of the SiC. If exposed to oxygen, it is intended to form a protective SiO₂ thermally grown oxide (TGO) layer, thereby avoiding decomposition of the SiC to SiO₂ and (gaseous) CO. This was covered by a layer of mullite to impede diffusion of oxygen to the silicon bond coat, and by a ytterbium monosilicate topcoat that has a very low silica volatility and protects the mullite and silicon layers from volatilization by water vapor.

To achieve robust performance the EBC must be designed and fabricated from materials that provide (and retain) complete aerial protection from oxygen and water vapor penetration for up to 5,000-10,000 hours of operation at gas path temperatures approaching 1500° C. Such EBC's must also not fail by coating fracture or delamination during repeated thermal cycling; must be able to survive impact by small and large particles (exhibit erosion and FOD resistance); and be able to survive exposure to molten CMAS and various salts that are present in fuel and the naval engine operating environments.

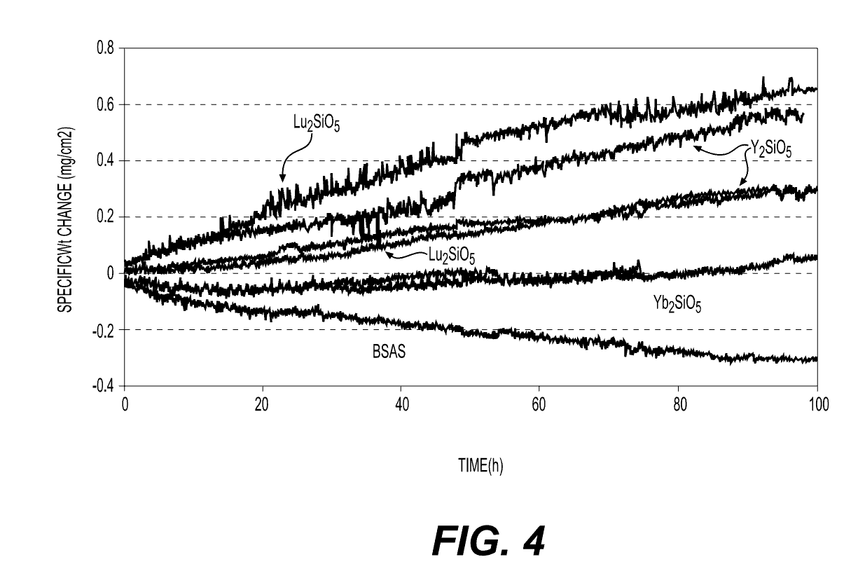

The use of Yb₂SiO₅ (YbMS) is based upon its very low volatility in steam environments, as shown in FIG. 4. The data shows the response to a 100 h exposure of the EBC material in a 50% H₂O/50% O₂ environment flowing across the specimen surface at flow rate of 4.4 cm/s and temperature of 1500° C., and a coefficient of thermal expansion (CTE) compatible with that of SiC. However, contradictory CTE data for this material was reported, and so careful dilatometry was performed on spark plasma sintered test coupons of the stoichiometric YbMS compound. These measurements indicate that the CTE varies from 5.7 to 9.1×10⁻⁶° C.⁻¹ which is much greater than that of SiC (4.5-5.5×10⁻⁶° C.⁻¹). The use of Yb₂Si₂O₇ ytterbium disilicate (YbDS) as a top coat has a much closer CTE (4.1×10⁻⁶° C.⁻¹) to that of SiC, but is less resistant to steam volatilization.

### APS Deposition System

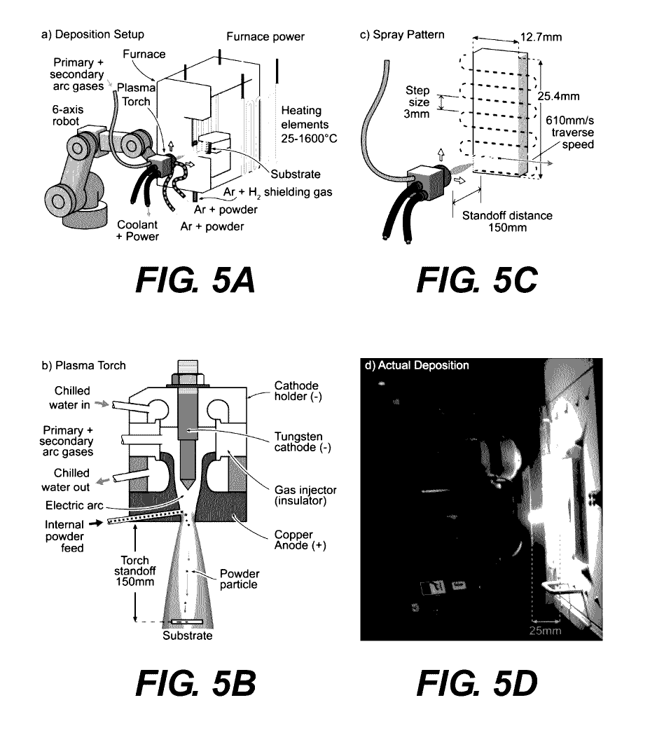

The study of advanced EBCs began with the design and assembly a state of a state of the art, robotically controlled, air plasma spray system shown in FIGS. 5A-5D. Extensive studies were performed to identify the best source powders, plasma gas composition, and identify the optimum spray conditions for the deposition of tri-layer EBC systems upon SiC substrates.

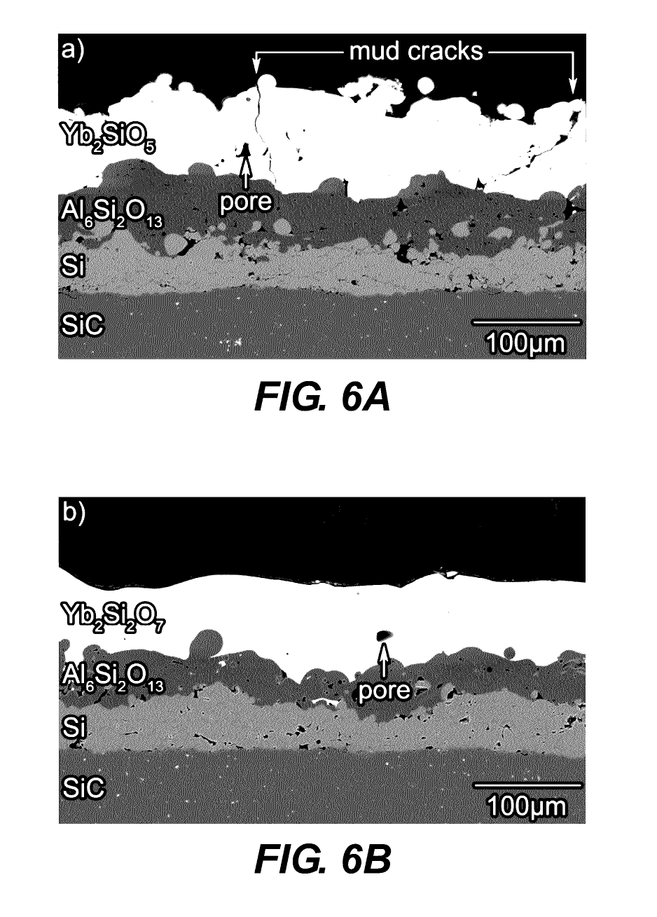

FIGS. 6A and 6B show cross sectional micrographs of the two tri-layer EBC systems deposited using the optimized deposition process. The micrographs were taken using the backscattered electron (BSE) mode of imaging in the SEM (light contrast corresponds to a higher local concentration of high atomic number elements). FIG. 6A shows that the high CTE of the YbMS layer causes mud cracking of the top coat. The BSE mode images also reveal that some molten droplets lost substantial SiO during plasma heating (they appear whiter in BSE mode imaging because of their higher concentration of Yb). FIG. 6B shows that the mud-cracking problem is not encountered in the YbDS topcoat system, though SiO loss still occurs, resulting in the presence of regions of lighter contrast YbMS in the majority disilicate coating.

A steam-cycling furnace based upon a design provided by NASA Glenn investigated the response of the YbMS top coat EBC system to steam cycling using a 1 hr hold time at 1316° C. (2400° F.) in a 90% H₂O+10% O₂ flowing environment (4.4 cm/s flow rate). The coatings made by the optimized process is compare to the response of coatings deposited with plasma spray systems at NASA Glenn, which were operated at much higher spray power settings.

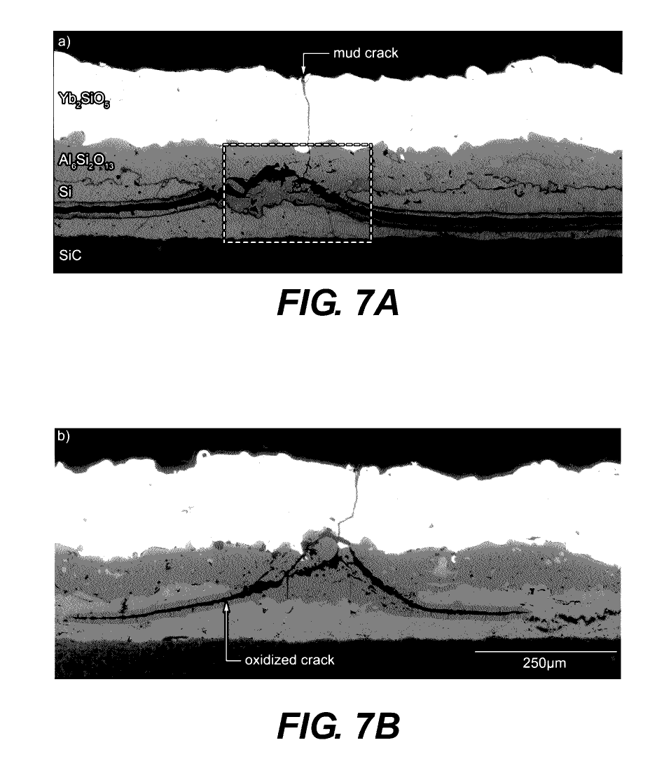

Delamination of the optimized coatings began after approximately 250 steam cycles, and all the samples failed within 725 cycles. The failure mode can be seen in FIGS. 7A and 7B.

The top coat suffered negligible steam erosion, as expected given the very low silica activity of this topcoat material. However, the top coats propensity for mud cracking resulted in the early penetration of cracks through the mullite and into the silicon layer where they bifurcated. This allowed oxidizing species to reach the interior of the silicon bond coat rapidly, and resulted in the progressive formation of a TGO layer on the crack faces, which then laterally extended to cause failure.

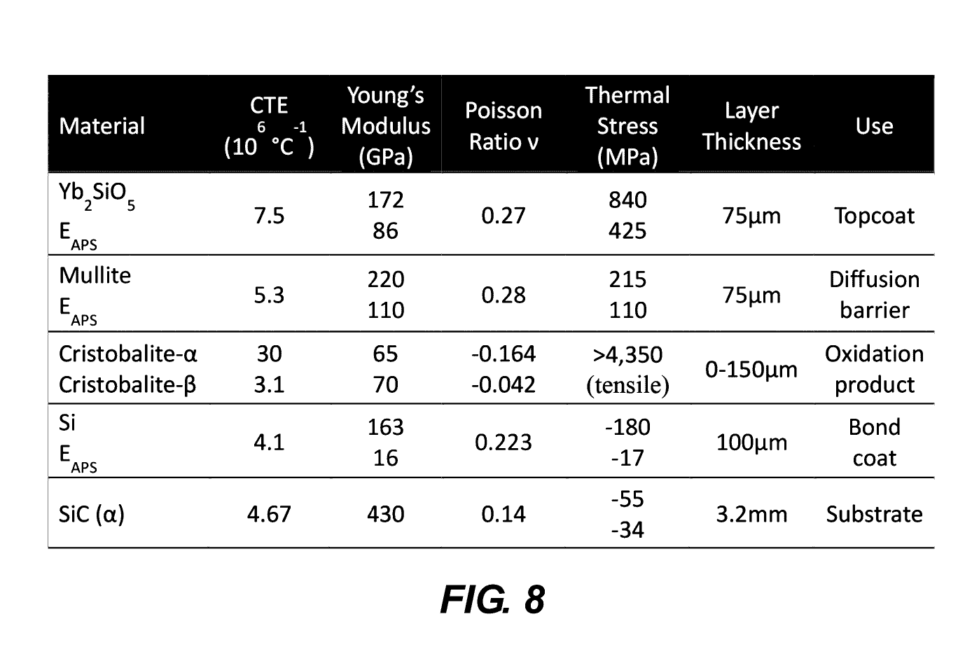

Raman spectroscopy identified the silicon bond coat TGO as α-phase cristobalite which had presumably formed as β-cristobalite at 1316° C., and transformed to the α-phase at 220° C. on cooling. There is a substantial (˜4%) volumetric contraction associated with the transformation which created a substantial stored elastic strain energy to drive delamination and other cracking processes. Insight into this was gained via collaborations with Begley (UCSB) by performing residual stress calculations assuming the system remained elastic during cooling from a stress free temperature of 1300° C., as shown in FIG. 8. The calculation used both handbook values for bulk material properties and those measured here for the APS coatings. It is evident that the porosity introduced by the spray process significantly reduced the residual stresses, and thus driving force for the coating failure processes. Three other important findings emerge from the results shown in FIG. 8. First the tensile stress in the YbMS layer is very high and was relieved by mud cracking with an inter-crack spacing of 150 μm. Second, the residual stress in the silicon bond coat was weakly compressive which makes mud crack extension to the SiC substrate energetically unfavorable. Finally, the phase transformation of the TGO creates a very high tensile stress in the TGO which results in TGO layer mud cracking and partial loss of the protective nature of this silica scale.

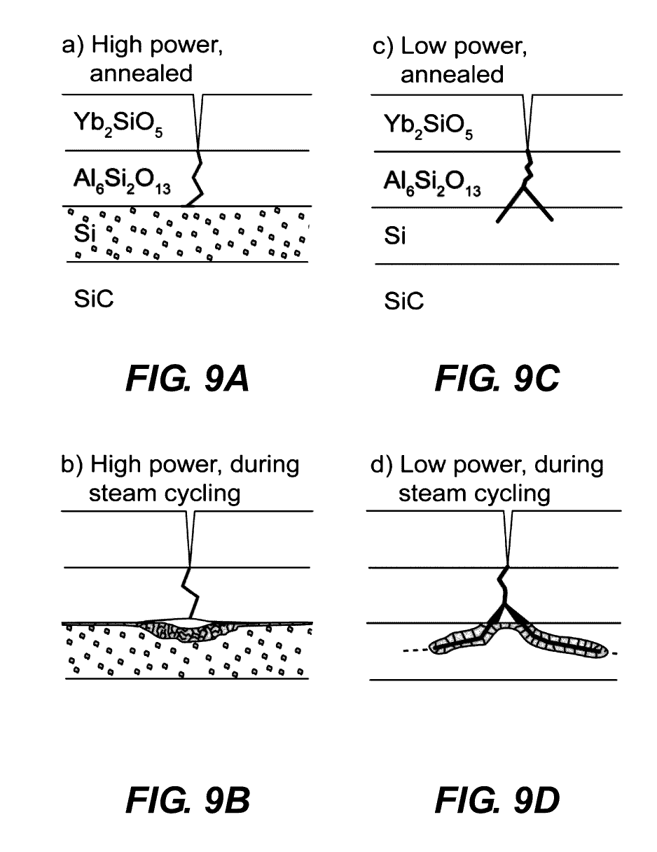

A schematic illustration of the failure mechanism during steam cycling is shown in FIGS. 9C and 9D for coatings optimally deposited using low plasma power deposition (to reduce SiO loss). It is compared with that discovered for high spray coatings with more porous (and internally oxidized) silicon bond coats shown in FIGS. 9A and 9B. After deposition and stabilization annealing of the tri-layer EBC, the high residual stresses created mud cracks and fast pathways for oxidizing species to reach the bond coat in both systems.

Detailed FEM calculations of the cracking mechanics indicate very similar energy release rates for fracture by single crack penetration to the bond coat and crack tip bifurcation in the mullite layer. Steam cycling of the two systems then resulted in crack tip localized oxidation of the Si bond coat and extension of the cracks. In one case, the cracks extended at the silicon-mullite interface while in the low spray power case, fracture progresses through the Si layer.

These findings led to a recognition that the YbMS system cannot be used as a top coat because of its propensity to mud crack. The mullite layer also provides little benefit, since its relatively high CTE, as shown in FIG. 8, and also leads to cracking during thermal cycling, and a loss of its diffusion barrier performance.

The YbDS topcoat system is deposited directly upon the silicon bond coat.

### Steam Cycling of YbDS/Si Bilayer EBC

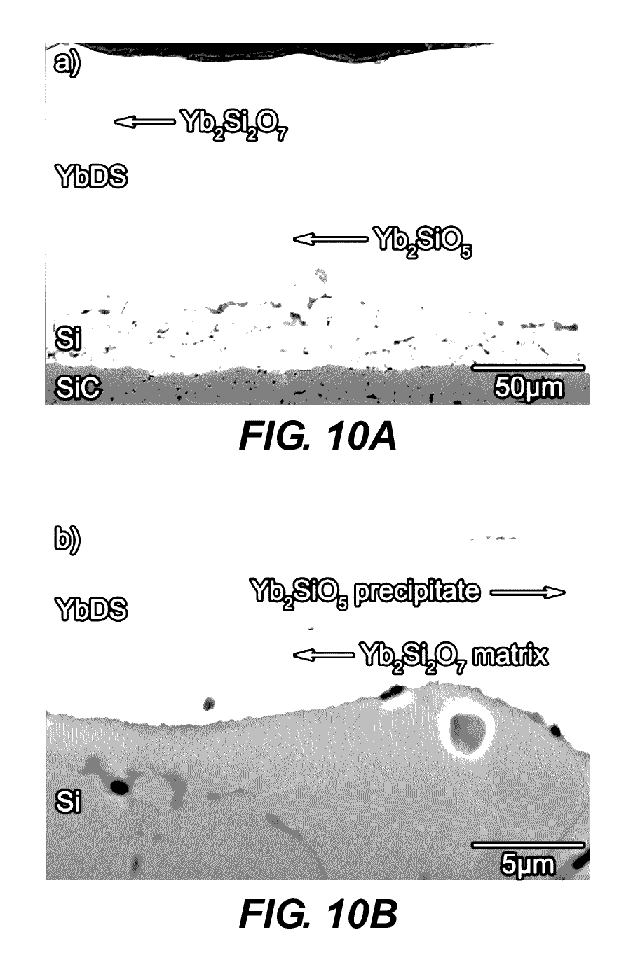

The microstructure of the as-deposited two layer (YbDS/Si) coating system is shown in FIGS. 10A and 10B. Excellent adhesion between the bond coat and SiC is achieved by careful roughening of the SiC surface. A 50 μm thick bond coat layer is deposited at 1200° C. in a reducing (Ar/H₂) atmosphere. It contains about 5% porosity. The 125 μm thick YbDS top coat is again deposited at 1200° C., but this time without a protective reducing gas atmosphere.

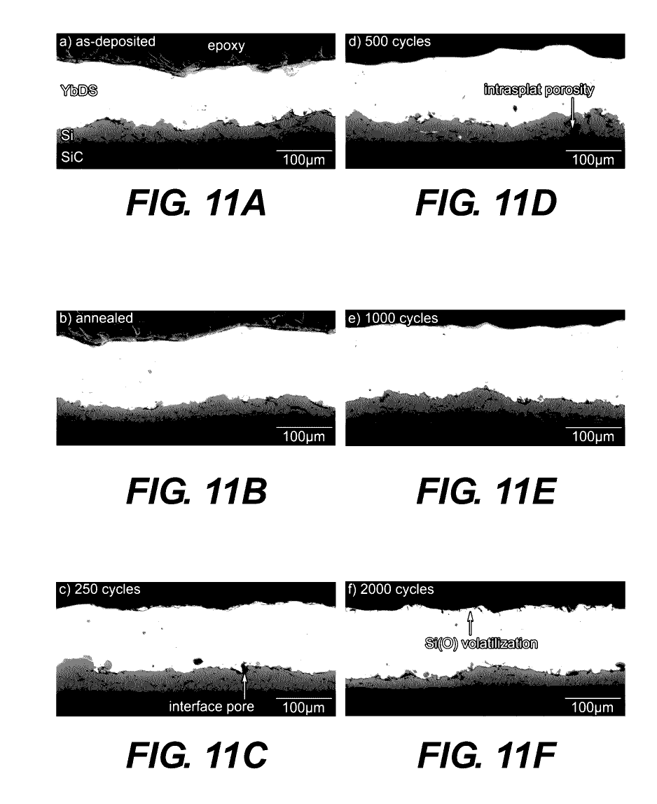

FIG. 10A shows that a dense, mud crack free topcoat is achieved. It can also be seen that the top coat contains SiO depleted splats. High magnification analysis indicates the lighter contrast splats were composed of the Yb₂SiO₅ line compound and in a Yb₂Si₂O₇ matrix. The splats with a highest YbMS fraction microcrack, but these cracks remained isolated, and do not provide fast oxidizer transport pathways to the bond coat. The YbDS/Si system subject to steam cycling is shown in FIGS. 11A-11F.

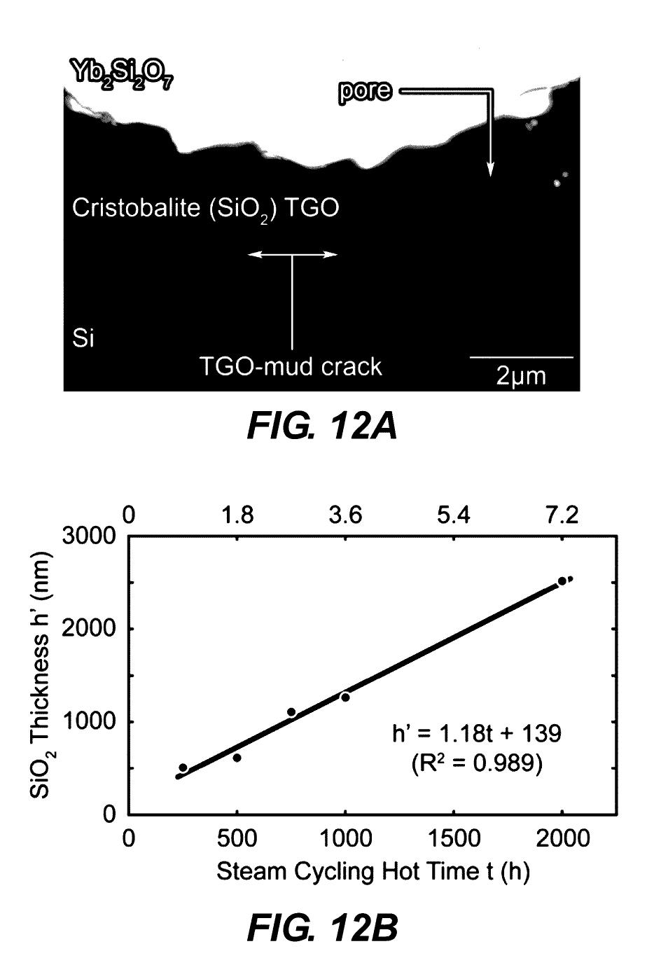

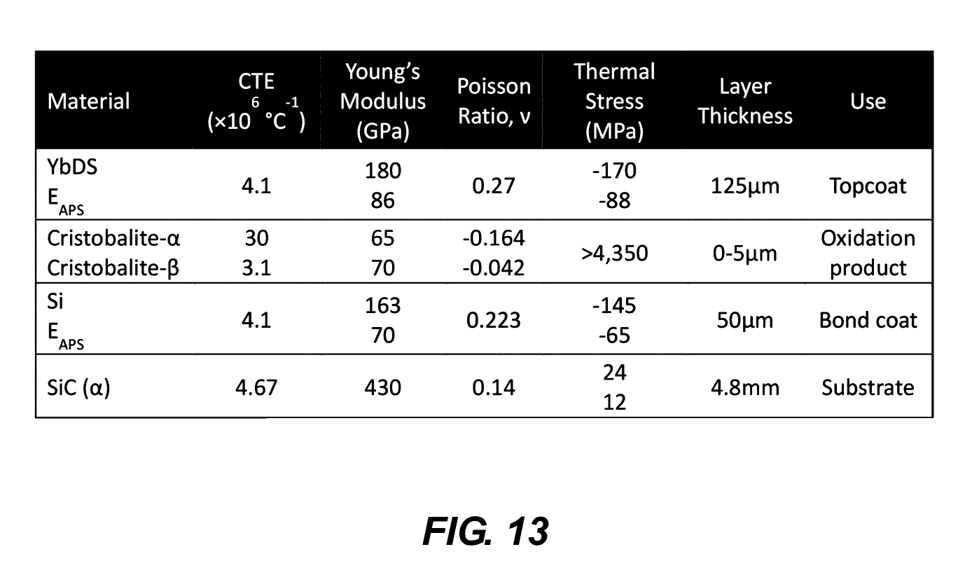

Steam cycling of the YbDS/Si system does not result in spallation (other than at less protected edges of the samples). Instead, a TGO layer slowly develops on the Si bond coat. An example is shown in 12A. The TGO again consisted of α-cristobalite which has mud cracks upon cooling because of the very biaxial tension stress developed in the layer upon cooling, as shown in FIG. 13. The linear growth kinetics were found to be governed by those for oxygen diffusion through the YbDS top coat, as shown in FIG. 12B.

### Creep Resistance of EBC System Materials

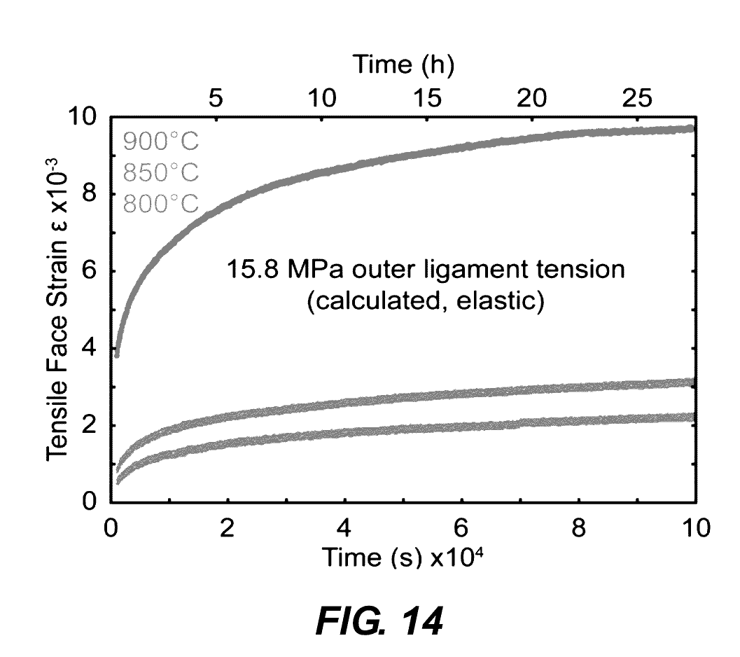

If EBC systems are applied to rotating components in gas turbine engines, they will be required to sustain stresses of ˜100 MPa at 1316° C. (2400° F.) for many thousands of hours of operation. To investigate the dimensional stability of the YbDS top coat to such conditions, APS deposited thick blocks of the topcoat silicate are made to make up flexural creep specimens. These are then isothermally (and in some cases thermal gradient) tested to obtain preliminary estimates of their flexural creep susceptibility using test facilities located at NASA Glenn. As shown in FIG. 14, it can be seen that the APS condition YbDS suffers a 1% creep strain in about 25 hours when tested at a stress of 15.8 MPa. Similar experiments with the Si bond coat revealed very high creep rates occurred with this material as well. These observations lead to the conclusion that while the YbDS/Si system may be suited for stationary applications in steam rich environments, it would be unable to survive service on rotating components.

### CMAS Interactions

Molten silicate (CMAS) degradation of thermal and environmental barrier coatings is viewed as a fundamental obstacle to achieving higher operating temperatures and improved efficiency in gas turbine engine. These deposits are derived from siliceous minerals (dust, sand, volcanic ash, debris) that enter into the gas turbine with the intake air and deposit on the surface of EBCs. They form glassy melts which react rapidly with silicate EBC materials, leading to degradation and loss of the EBC system. The CAS problem becomes serious only after the gas flow temperature at the high pressure turbine inlet begins to exceed the melting temperature of CMAS (˜1200° C.), and is increasingly a concern for aircraft engines that operate in desert or volcanic ash-containing environments. The introduction of SiC components into engines leads to further increases in the gas flow temperatures that can make this CMAS issue even more challenging.

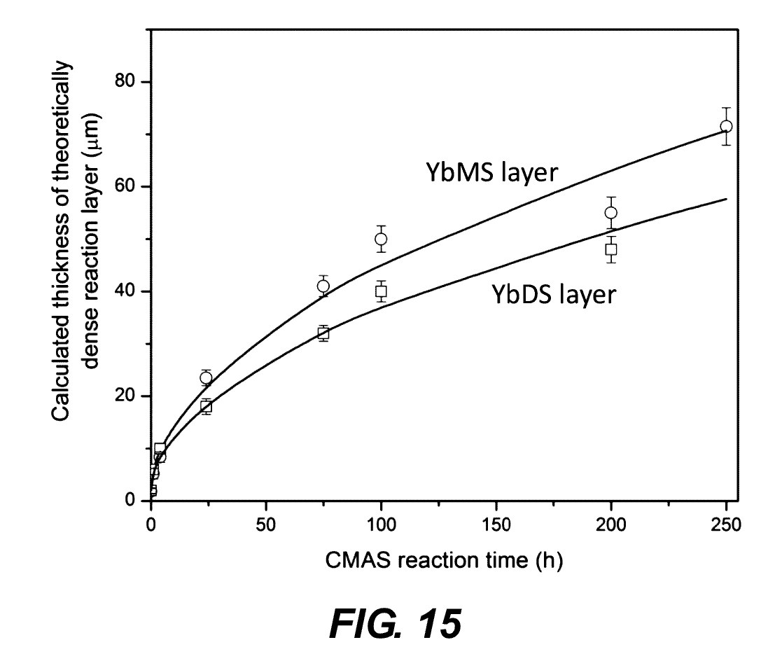

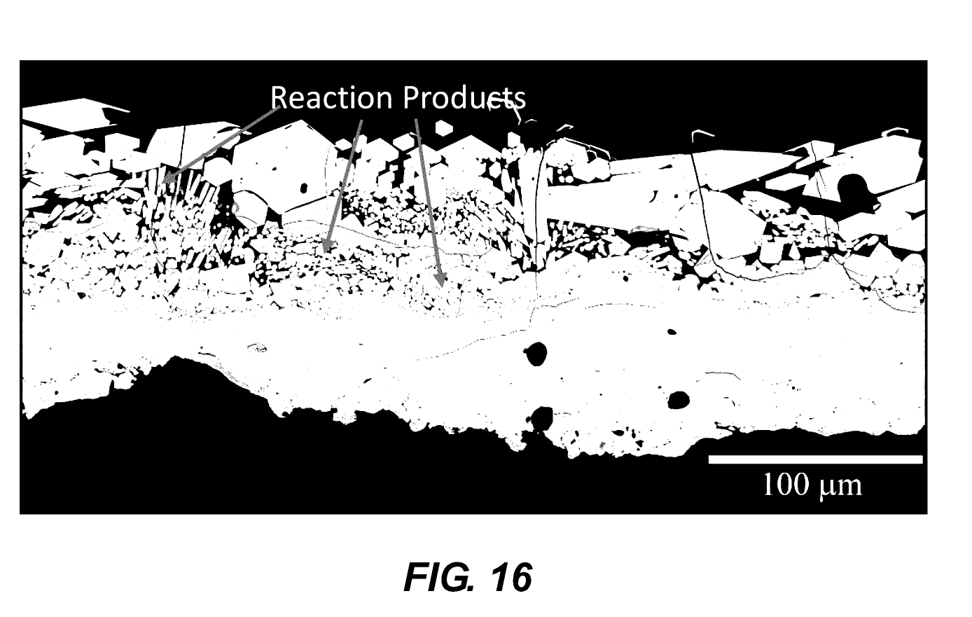

The reaction rate between YbMS and YbDS coatings with CMAS is summarized in FIG. 15. The reaction is rapid in both materials at 1300° C. However, the APS deposited reaction rate of the YbMS coating appears a little higher than that of the disilicate. A micrograph of a typical reaction between CMAS and an APS deposited YbDS coating is shown in FIG. 16. The reaction product is a hexagonal oxyapatite silicate phase with the composition of Ca₂Yb₈(SiO₄)6O₂.

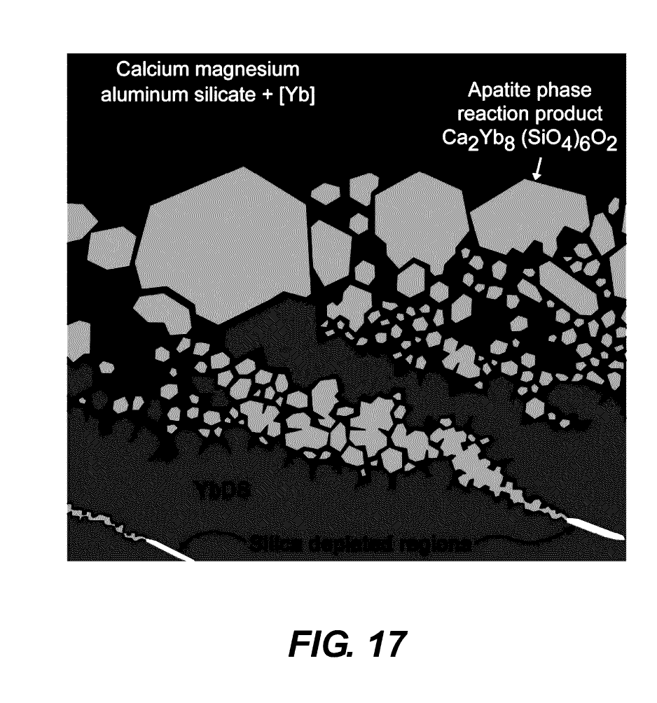

The reaction mechanism in the APS deposited coatings is more complex than that reported for monolithic materials. EDS measurements reveal a significant dissolution of Yb into the CMAS melt, and a differential rate of reaction between the YbDS and YbMS rich regions of the coatings. The situation is schematically illustrated in FIG. 17. The reaction front penetrated most rapidly into the YbMS rich regions of the structure leaving isolated YbDS grains to react more slowly with CMAS melt.

The current method identifies the existence of a viable solution for the environmental protection of nonrotating SiC composite components in gas turbine engines. Using appropriately optimized APS deposition processes, a silicon bond coat that is covered by an approximately 150 μm thick YbDS top coat has the potential to provide several thousand hours of protection at 1316° C. (2400° F.), provided surface flow velocity is low and exposure to CMAS deposits is minimized.

However, it is noted that thicker or more protective coatings are needed as the local flow velocity is increased (e.g. 1 mm thick YbDS layer for a flow velocity of 100 ms⁻¹). The next advance is the implementation of an analogous EBC protection concept for use on rotating components subjected to the same temperature. These rotated components are in the high-speed flow path, and are subjected to intense thermal cycling requiring improved steam erosion and delamination resistance. They are also subjected to a variety of mechanical loads and must therefore have significant resistance to creep. Ideally, the chosen approach provides a pathway towards the eventual development of environmental protection concepts for rotated components operating at 1482° C. (2700° F.).

One of the key objectives is to exploit the sophisticated coating deposition expertise to explore deformation resistant EBC coating systems capable of operation at 2400° F. on rotated structures. The use of air plasma spray and vapor deposition methods for deposition of advanced environmental barrier coating systems on SiC test coupons that have compositions that can survive the steam rich engine environment can be studied. The study can investigate, among other things, the fundamental phenomena governing the resistance of the coatings to imposed (centripetal) stresses, and the stress relaxation processes active in coatings subjected to severe temperature gradients. The insights gained from the study will culminate in the identification of new materials and coating architectures that enable EBC protection to be extended to rotated components operating at 2400° F. These insights can be used to suggest silicon bond coat replacements (melting temperature of silicon is 1410° C.) that might extend the use temperature of future CMCs to 2700° F. target application.

The discovery and development of affordable and reliable manufacturing methods for applying EBC systems to CMC components can benefit the performance and life cycle (operating) costs of several advanced turbine engines within the Navy that specifically require improved durability. This includes future variants of the Joint Strike Fighter (JSF) engine which will have higher engine operating temperatures over time, future engines for the joint unmanned combat air system (J-UCAS) where current approaches use existing legacy engines (such as the F404) in extreme environments (high thermal loads or long duration missions), and engines for the F-18 replacement that will require long range and super cruise capability. This will be achieved through reduced fuel consumption due to increased operating temperatures as well as reduced maintenance in comparison to systems utilizing TBCs which require numerous reapplications of the thermal protection system over the engine lifetime.

A goal of the method, among others, is the design of creep and thermal shock resistant EBC systems suitable for use on rotating components in the high velocity, steam rich combustion gas flow characteristic of advanced gas turbine engines. The approach combines, among other things, high temperature material combination selection, novel coating deposition concepts, microstructure characterization, high temperature failure mechanism investigations and chemical transport/micromechanical analysis to develop a comprehensive understanding of the factors influencing the durability of EBCs on rotating components exposed to gas flow temperatures of 1316° C.

### High Temperature Materials Selection

The approach seeks to, but not limited thereto, increase the creep resistance of the YbDS/Si system whose thermomechanical behavior and oxidation resistance appear well matched to the needs of the 1316° C. application. This will also exploit multifunctional opportunities afforded by this creep reinforcement approach. These include reduction of the steam erosion rate of the protection system (which is likely to be necessary in the high gas flow speed environment of a rotating component) and avoidance of cristobalite TGO formation (which drives premature delamination).

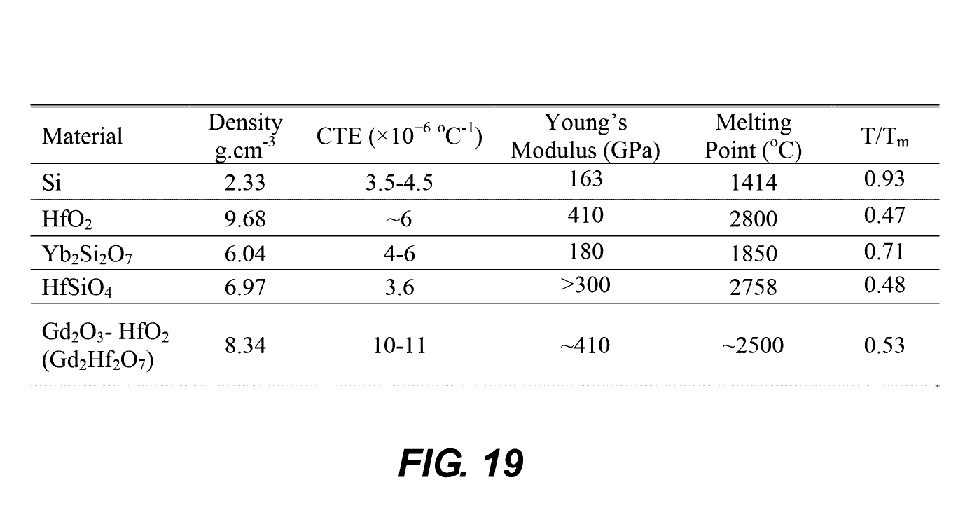

The creep resistance of both the Si bond coat and outer YbDS layer of a two-layer EBC can be improved by the incorporation of a creep resistant reinforcement aligned with the in-plane loading direction. Since the creep rate increases with homologous temperature, the creep resistant material should have a low homologous temperature at the operating temperature. There are several candidate materials that could be explored, but the study will begin by using HfO₂. Its homologous temperature at 1316° C. is 0.47, as shown in FIG. 19. Thermochemical stability is a major concern driving this choice.

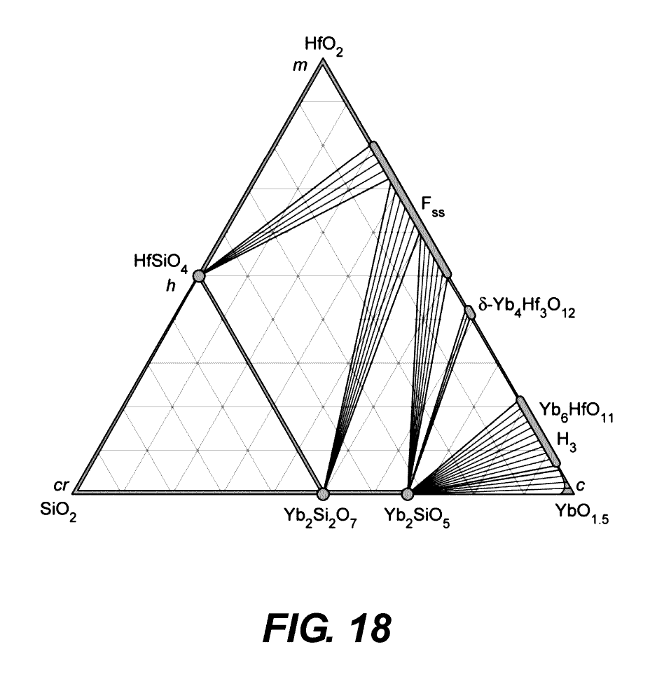

A preliminary ternary phase diagram for the SiO₂—YbO_{1.5}—HfO₂ system at 1500° C.¹⁸ is shown in FIG. 18. It indicates that both YbDS and HfO₂ coexist in thermochemical equilibrium at the elevated temperature of interest. It also indicates that a cristobalite TGO in contact with HfO₂ will react to form HfSiO₄ (Hafnon), a stable phase with a CTE well matched to other components of the system, as shown in FIG. 19. HfSiO4 is additionally stable when in contact with YbDS. Phase equilibria calculations also indicate that Si and HfO2 are stable at the EBC use temperature. Thus, all of the primary components and oxidation reaction products of an EBC coating containing HfO2 as a creep reinforcement of both the Si bond coat and YbDS layer exhibit mutual thermochemical stability.

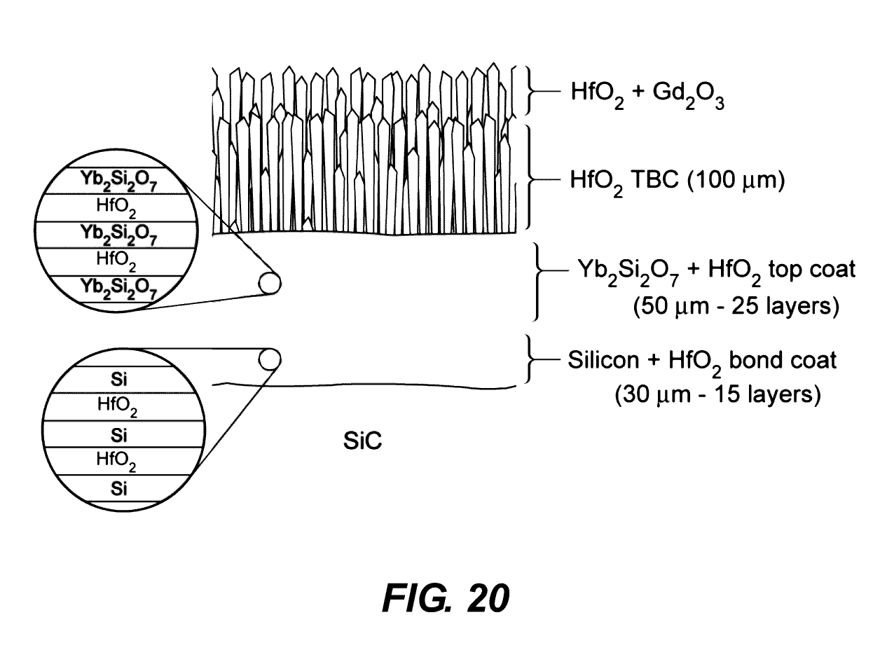

FIG. 20 shows a schematic illustration of the creep resistant EBC to be investigated. The coating will consist of a silicon+HfO₂ bond coat, a HfO₂+rare earth disilicate silicate (Yb₂Si₂O₇) environmental barrier and finally a HfO₂ TBC top coat. This TBC top coat is intended to serve at least three roles: It will reduce the rate of steam volatilization of the YbDS layer, it decreases the temperature of the underlying layers reducing their environmental damage and creep rates, and it provides protection from CMAS attack by the incorporation of gadolina in the Hafnia. It is noted that HfO2 has a very low steam volatility. These novel coatings will be applied to monolithic polycrystalline α-SiC test coupons using both the electron beam-coaxial plasma deposition (EB-CPD) and APS methods. Identification of the wavelength of the multilayers in the bond coat and YbDS/HfO₂ layer will be determined via a series of initial experiments that will explore the relationships between the in-plane creep rate and layer architecture and component volume fractions.

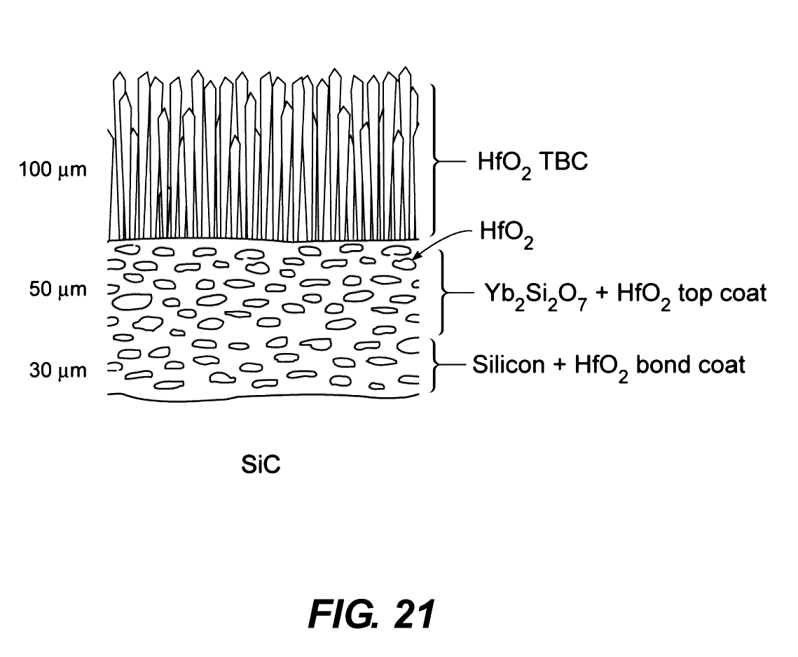

It is noted that the Si—HfO₂ and YbDS-HfO₂ structures in FIG. 20 are likely to undergo morphological changes during high temperature exposure, resulting in a structure like that shown in FIG. 21. Provided the in-plane length to through thickness width of the HfO2 phase remains high, the structure is still expected to retain considerable creep resistance. Such a structure can be inexpensively deposited using our APS capability and be investigated in the program.

The failure mechanisms of state of the art thermal/environmental barrier coatings can be experimentally explored, and can be related to processing variables. Specific coating failure mechanisms to be investigated include coating fracture and delamination resulting from thermal expansion differences between protection system components and the substrate, erosion and failure of the coatings due to the coupled effects of oxygen diffusion through the coatings with water vapor induced oxidation and volatilization of the resulting silica compounds, and reactive attack by calcium magnesium aluminum silicate deposits.

### Coating Deposition

A first deposit of the coating systems will use vapor techniques developed for the growth of thermal barrier coating systems. The system allows four (4) source materials to be sequentially (or simultaneously) melted and evaporated by impingement of intense electron beams on their surfaces. In operation, up to four (partially consolidated) powder sources are placed in a compound water-cooled copper crucible located in the throat of an inert gas jet-forming nozzle. By maintaining a pressure ratio of at least two (2) between the pressure up and downstream of the nozzle, it is possible to use gas expansion to create a supersonic gas jet with a velocity that can be varied by changing the gas composition, temperature, the nozzle's geometry, and the up to downstream pressure ratio. The use of helium allows jets with velocities in the 1,000 m/s range to be achieved at downstream pressures in the 10-100 Pa range. These can efficiently entrain, mix and deposit coatings at high rates (many 10's of micrometers per minute).

If the substrate is held at a homologous temperature T/Tₘ around 0.35 (Tₘ is the absolute melting temperature), the atoms and molecules that are deposited low surface mobility resulting in porous, columnar deposits, ideally suited for TBC applications. The HfO₂ (with gadolina doping) TBC topcoat will therefore be deposited without the use of plasma assistance. If the coating surface temperature increased to homologous temperatures in the 0.7-0.8 range, fully dense coatings (like those needed for the bond coat and volatility resistant layers) can be made. However, the materials of interest have very high melting temperatures requiring very high substrate temperatures for their deposition.

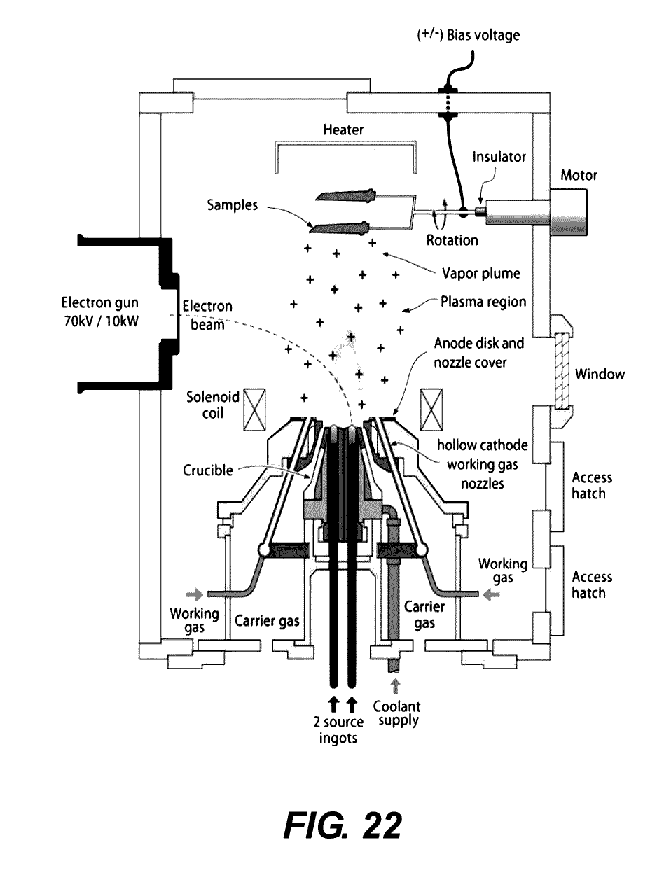

The approach proposed here utilizes plasma assistance in which ionized heavy inert gas ions (such as Ar⁺) are electrostatically attracted to the growth surface and their impact provides activation of atomic reassembly processes. A schematic illustration of the electron beam coaxial plasma deposition (EB-CPD) system is shown in FIG. 22. A ring of plasma forming hollow cathode plasma jets encircle this nozzle, creating an intense plasma. By applying a bias voltage to the substrate high-energy ion impacts can be used to create dense coatings. The high ion velocity (and thus the kinetic energy) allows the coating density to be increased without resorting to increases in deposition temperature and therefore large residual stresses upon cooling. Plasma assistance can also reduce the likelihood of amorphous deposition. These characteristics combine to make this EB-CPD approach a useful tool for the development of EBC coatings.

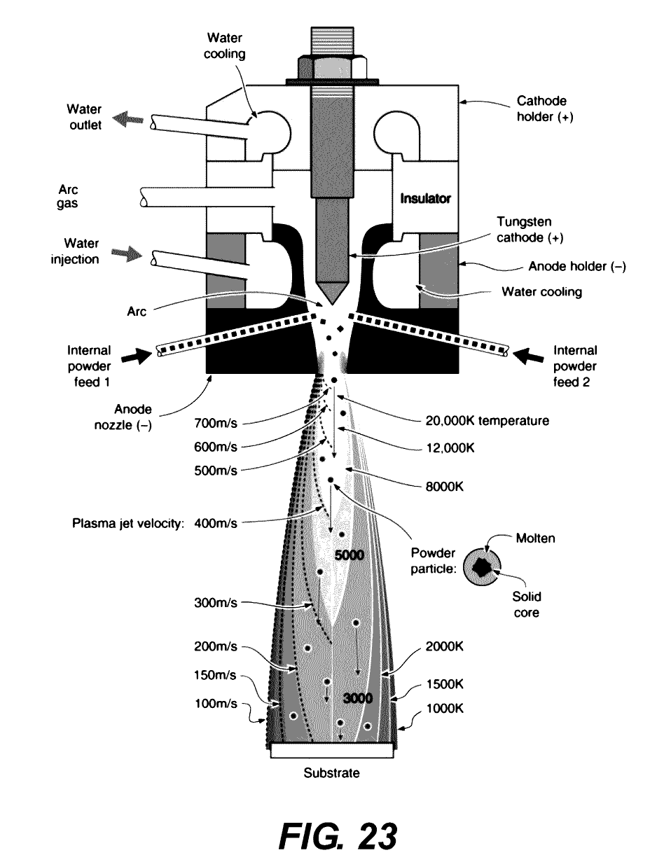

An air plasma spray system with two powder feeds is used to deposit the coatings above. FIG. 23 shows a schematic illustration of the gun that will be used. The gun is part of a model 7700 UPC air plasma spray (APS) system built by Praxair-TAFA. It utilizes fully digital closed loop control of the APS process including gun manipulation with a 6-axis ABB robot, IR pyrometer system for work-piece thermal management, multiple carrier and secondary gas options (including hydrogen), and a dual powder injection system for spraying two powders either sequentially or simultaneously.

Control of the phases formed during deposition can be achieved by (i) controlling the residence time of the particles and the enthalpy of the plasma jet (which control the droplet temperature and heat flux) and (ii) adjustment of the temperature of the substrate as each layer is deposited. Heat treatment of the powders prior to deposition can be used to ensure that the most stable high temperature phase exists prior to spraying, though powders are generally purchased in phase pure. Partial melting of specialty powders that contain crystal-nucleating cores can then be used to avoid the formation of metastable phases including vitreous deposits.

### Microstructure Characterization

X-ray diffraction methods, BSE mode SEM, EDS compositional analysis and FIB sectioned TEM samples can be used to characterize both the powder particles before and after heat treatment and the deposited structures after initial cooling and stabilization annealing. Particular attention should be paid to the interfacial structures that form between the HfO₂—YbDS and HfO₂—Si interfaces during deposition as well the reinforcing phase shape. During high temperature thermal exposure of the system, morphological changes to the reinforcement will be investigated and the formation of a hafnon TGO carefully characterized. A high-resolution μ-XCT system will be investigated as a means to nondestructively characterize the evolution of the coatings periodically during thermal testing.

FIG. 19 indicates that while the CTE values of the constituent materials are quite closely matched, residual stresses are still likely to be formed upon cooling and from through-thickness thermal gradients present during spray deposition and some testing approaches. Computational approaches can be used to estimate these stresses, but in systems where significant creep relaxation can occur, it is advisable to perform experimental checks. We will seek to use the high-resolution x-ray diffraction facilities at the Advance Light Source to measure these stress gradients and if necessary, investigate novel growth strategies for their control during deposition.

### High Temperature Deformation and Failure Mechanisms

Tensile creep coupon samples of the HfO₂ reinforced silicon bond coat and YbDS layers with the axis of the reinforcement in the loading direction can be prepared. The creep strain dependence upon stress at several temperatures around 1316° C. can be measured, and the creep exponent and activation energy can be determined. Interrupted tests can be used to investigate microstructural changes, characterize micro-failure processes and to infer the creep mechanisms. These investigations will then be used to design coating morphologies that impede creep processes. Other experiments will investigate the basic mechanisms of coating cracking and delamination and its dependence upon layer thickness, interfacial toughness and composition.

### Chemical Reactions and Diffusional Transport

The program will explore, among other things, the fundamental mechanisms of water vapor volatilization in the creep resistant system. The volatility of HfO₂ is expected to be much less than YbDS, for it to therefore accumulate and protect the EBC surface. This can be carefully evaluated. The YbDS-HfO₂ layer can be coated with a HfO₂ TBC, and its effect upon reducing steam erosion of the EBC layer can be investigated. The study will also investigate the effects of CMAS exposure at surface temperatures up to 1400° C. and beyond on the HfO₂+Gd₂Hf₂O₇ TBC protected structure. In these experiments, thermal gradients will be set up by back cooling the substrates with compressed argon.

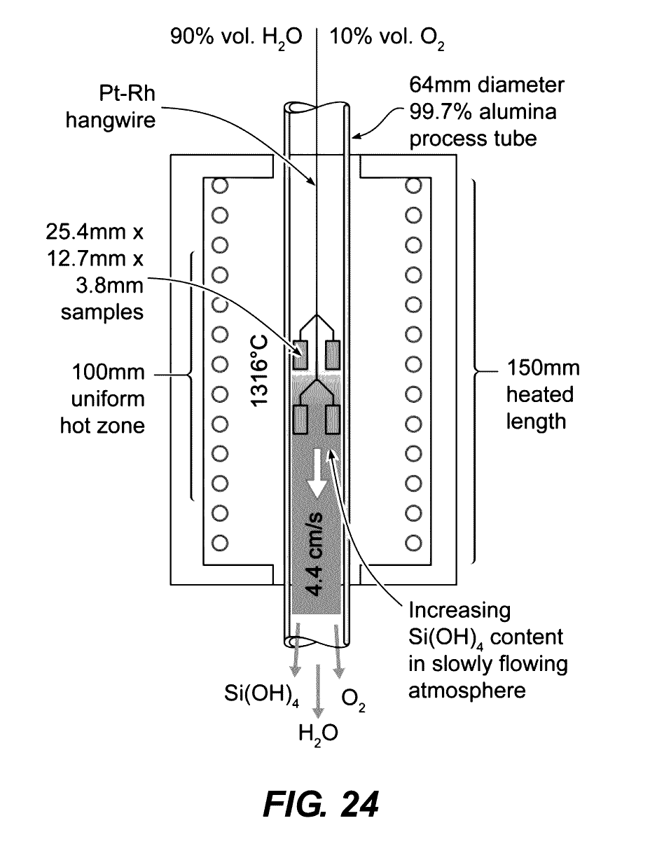

An environmentally controlled (steam) cycling furnace is assembled to measure the volatilization rates of the EBC system to be investigated in this program, as shown in FIG. 24. The vertical furnace is able to heat samples to temperatures of 1600° C. in a laminar flowing gas stream environment where the water vapor fraction can be varied from 0-100%. Rough surfaces can disrupt the boundary layer of a laminar flow across a surface. For example, small scale vortex formation at high Reynolds numbers leads to enhanced mixing and may promote accelerated and localized erosion. The introduction of gas jets into the steam-cycling furnace can be investigated so that much higher velocity water vapor jets can be transported across the sample surface. This will allow the effects of coating surface roughness on the boundary layer to be investigated. A discrete Monte Carlo simulation can be used to analyze the diffusion of water vapor towards, and silicon hydroxides away from the EBC surface. Efforts can be made to estimate the heterogeneous surface reaction kinetics and atomic mechanisms which will then be combined with vapor phase transport rates to provide predictive recession rate models.

The steam-cycling furnace allows samples to be programmably dropped from the hot zone into a cold region to allow thermal cycling and assessments of coating fracture and the effects of steady state silica scale growth on delamination to be evaluated. These experimental studies will be complemented with thermomechanical modeling to compute the residual stress and stored strain energies of the EBC systems. Measurements of the interfacial toughness on specially prepared microscale test coupons will be used with these analyses to understand the factors leading to cracking and delamination of the EBC systems. Samples with systematically varied coating thicknesses will also enable systematic variation of the crack driving forces in the system and an independent means for validation of thermomechanical fracture models.

This method seeks support for three sequential tasks.

### Task 1: Optimization of EBC/TBC Deposition

The objective of Task 1 is to develop economical plasma spray and vapor deposition methods for the controlled the morphology of creep resistant EBC/TBC systems on SiC coupons. The initial focus will be directed at a silicon+HfO2 bond coat with Yb₂Si₂O7+HfO₂ environmental barrier and HfO2+Gd₂Hf₂O₇ TBC top coat system. By using low power plasma spray deposition conditions that only partially melt the powder particles and variation of the substrate temperature, we will explore the opportunity to control the phases that are formed during deposition of the various coatings. The use of higher power plasma spray conditions enable us to evaporate a fraction of powder particles (the smaller diameter ones) and to deposit coatings by a combination of liquid droplet and vapor condensation methods. The directed vapor deposition approach allows us to extend this trend and deposit from just the vapor phase or from one that contains a significant mass fraction of nanoparticles to seed desired phases. We will investigate the mechanisms by which porosity is avoided in the coatings, and explore strategies for eliminating interconnected pores and splat boundaries that can provide diffusional short circuits to the easily volatized components of the system. The surfaces and interfaces of the coatings will be optimized to improve gas flow over the component surface and to better achieve longer (predictable) lifetimes.

### Task 2: Coating Failure Mechanisms

The failure mechanisms of these state of the art thermal/environmental barrier coatings can be experimentally explored. Coating failure mechanisms to be specifically investigated include coating fracture and delamination resulting from thermal expansion differences between protection system components and the substrate, environmental damage of the coatings due to the coupled effects of oxygen diffusion through the coatings and water vapor induced volatilization of the resulting silica compounds, impact damage caused by small particle impacts at velocities up to 300 m/s and reactive attack by calcium magnesium aluminum silicate deposits. Synchrotron based approaches to measure (the lattice parameter and thus) residual stress distributions in the coatings at a variety of temperatures as well as wafer curvature methods combined with layer removal can be used. These will then be used in conjunction with thermoelastic models to explore the use of processing variables (especially particle superheat and substrate temperature) during each layers deposition to control the stored strain energy in the EBC system.

### Task 3: Environment Reaction Control

Steam jets and thermogravimetric analysis (TGA) can be utilized to measure the volatilization rate of each of the EBC layer components and the EBC system. These experiments will be complimented with modeling of the gas phase transport of reactants/products to/from the steam-exposed surface. By independently varying both the steam flow conditions and substrate temperature, the kinetic factors that control silicon hydroxide volatility for the rare earth silicate system can be identified. Atomistic scale models will be used to rationalize the kinetics and identify promising strategies for reducing the volatilization rate. Some of the T/EBC systems will be exposed to CMAS at 1300-1400° C. and the mechanism of CMAS attack investigated. The transport of CMAS through inter-splat boundaries and the potential to retard this by process control of microstructure can be focused on. Very little data exists on the effect of CMAS surface reaction products on silica volatility. Some of the CMAS-reacted samples will therefore be tested using the steam jet furnace and TGA to measure volatilization rates and compare them with un-reacted samples.

The insights gained from these Tasks will provide a comprehensive understanding of the relationships between process methods and conditions used for EBC deposition and the mechanisms and rates of coating failure as surface temperatures are increased towards 1400° C. These new insights will be used to explore novel coating materials and multilayer architectures that promise to extend the life and increase the maximum use temperature of EBC systems. This will specifically include concepts to replace the silicon bond coat since its melting temperature (of 1410° C.) limits the maximum use temperature of future CMCs.

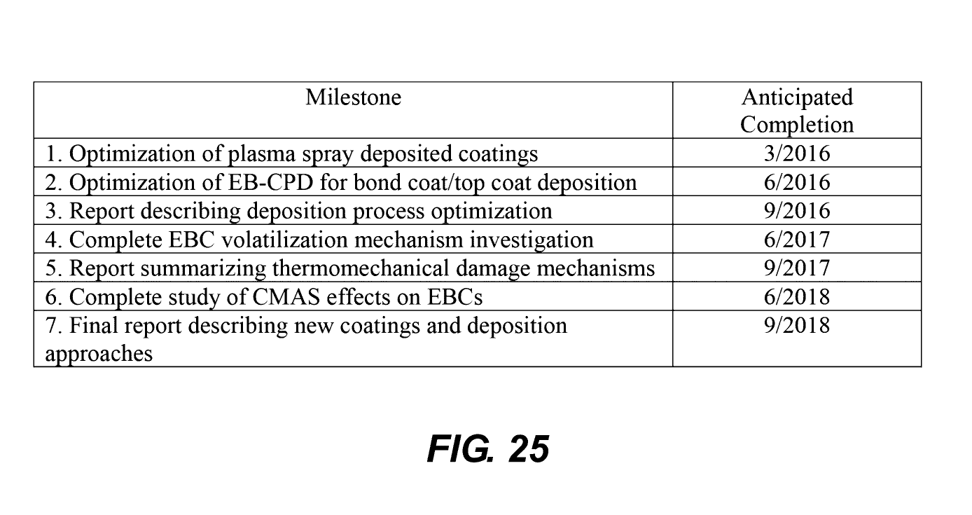

The key milestones are summarized in FIG. 25.

### Facilities

Facilities to support the research include: (1) a top of the line model 7700 UPC air plasma spray (APS) system manufactured by Praxair-TAFA that utilizes fully digital closed loop control of the APS process including gun manipulation using a 6-axis ABB robot, IR pyrometer system for work-piece thermal management, multiple carrier and secondary gas abilities including Hydrogen, and dual powder feed system for spraying two powders simultaneously; (2) a state-of-the-art EB-CPD synthesis tool that uses an e-beam in a low vacuum environment (˜10⁻³−1 Torr) to entrain the evaporant in a carrier gas stream, (simultaneous evaporation form four sources is possible); (3) a FLIR ThermaCAM SC3000 high speed thermal imaging camera having high resolution (320×240 pixels) and ultra high sensitivity (<20 mK at 30° C.); (4) a FEI Quanta 650 electron microprobe/SEM equipped with a field emission filament and both energy-dispersive (EDS) and wavelength-dispersive (WDS) X-ray detectors for high-resolution imaging (4 nm) and microanalysis of all elements down to boron in the Periodic Table; (5) a second FEI Quanta 200 electron microprobe/SEM equipped with a tungsten filament, as well as energy-dispersive (EDS) and wavelength-dispersive (WDS) X-ray detectors for high-resolution imaging (3.0 nm) and microanalysis of all elements down to boron in the Periodic Table; and (6) a PANalytical X'Pert PRO MPD X-ray diffractometer with X'celerator CCD line and proportional point detectors will allow crystal structure determination and coating texture measurements.

### Addition Detailed Description

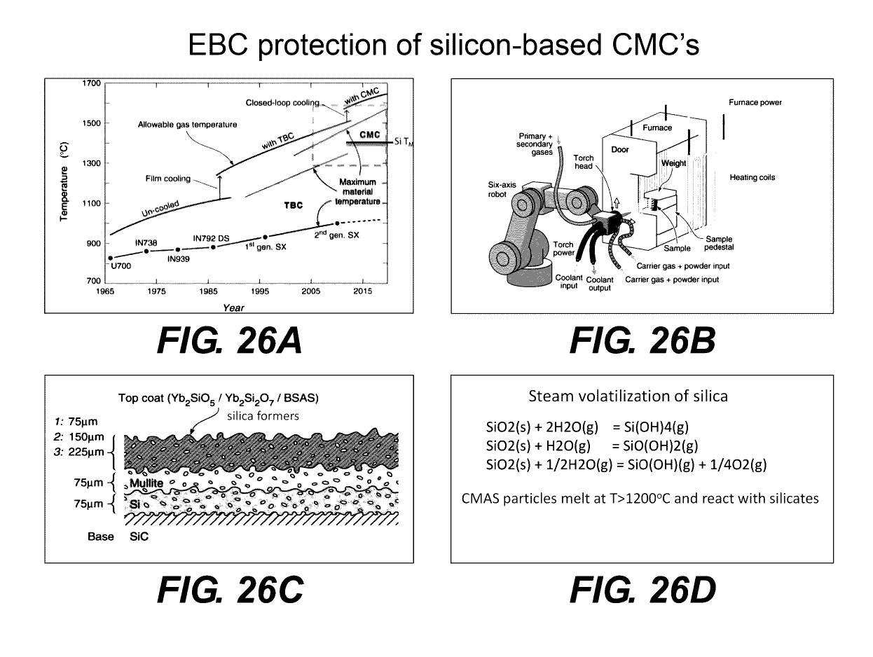

The EBC protection of silicon-based CMC's is shown in FIGS. 26A-26D. FIG. 26A shows the high temperature tolerance of CMC's. FIG. 26B shows the apparatus of application of the CMC coatings. FIG. 26C shows the resulting layering, including the SiC base or substrate, Si layer, Mullite layer, and topcoat of Yb₂SiO₅/Yb₂Si₂O₇/BSAS. The chemistry for the steam volitization of silica is shown in FIG. 26D.

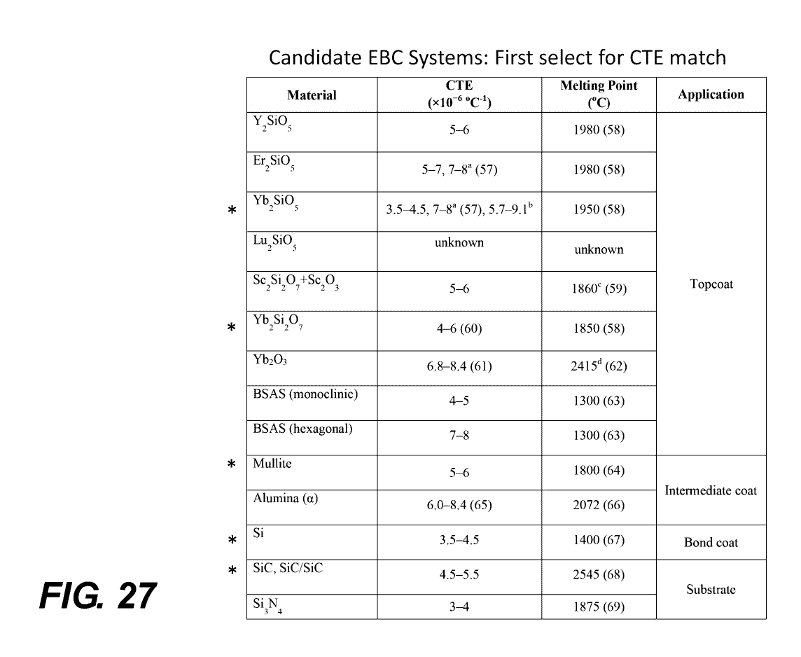

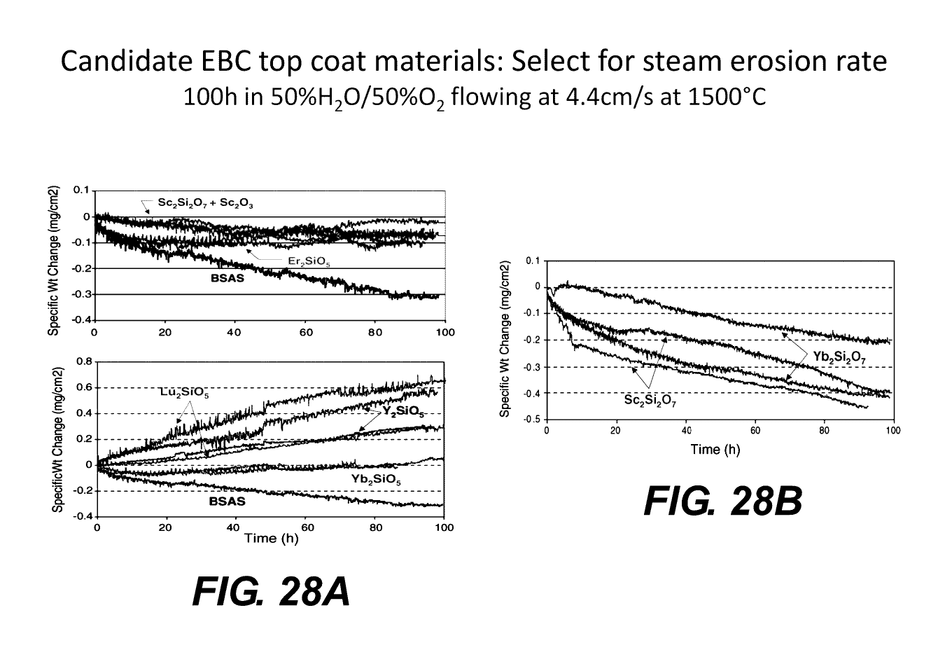

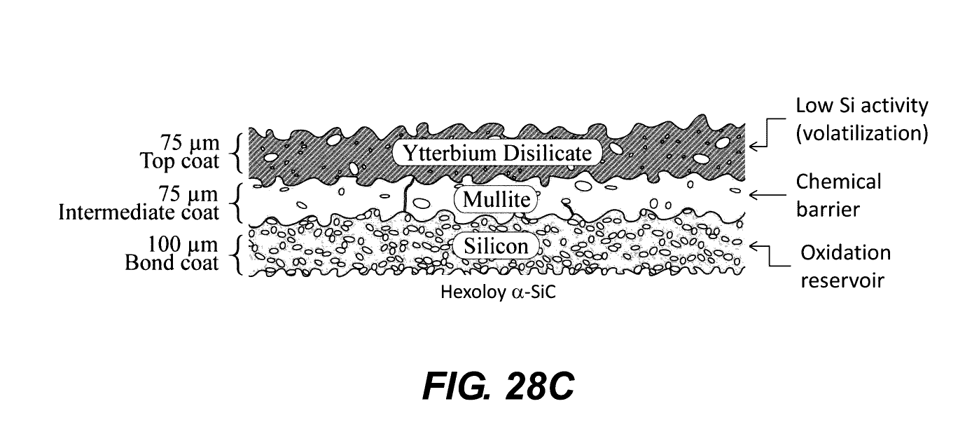

A table of material candidates for EBC systems is shown in FIG. 27, along with the CTE, melting point, and application. Graphical illustration of the steam erosion rates of some of the candidate EBC top coat materials is shown in FIGS. 28A and 28B.

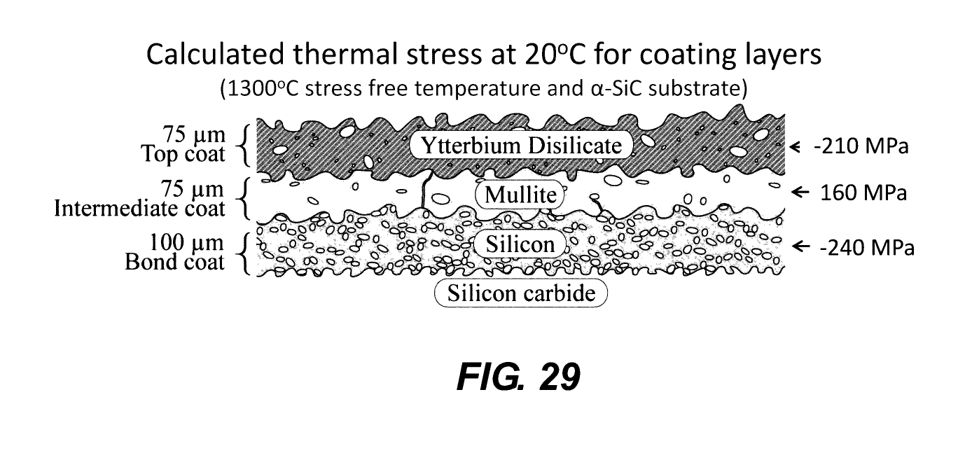

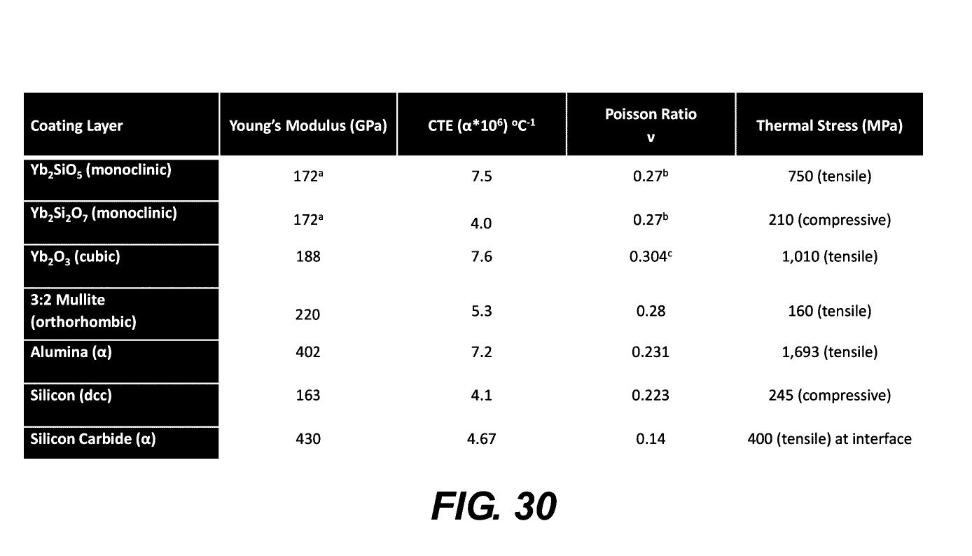

The layering structure or arrangement of the proactive coating is shown in FIG. 28C along with the thickness of the layers and the purpose or function of the particular layer. The calculated thermal stress of these layers is shown in FIG. 29. The properties of various coatings is shown in FIG. 30.

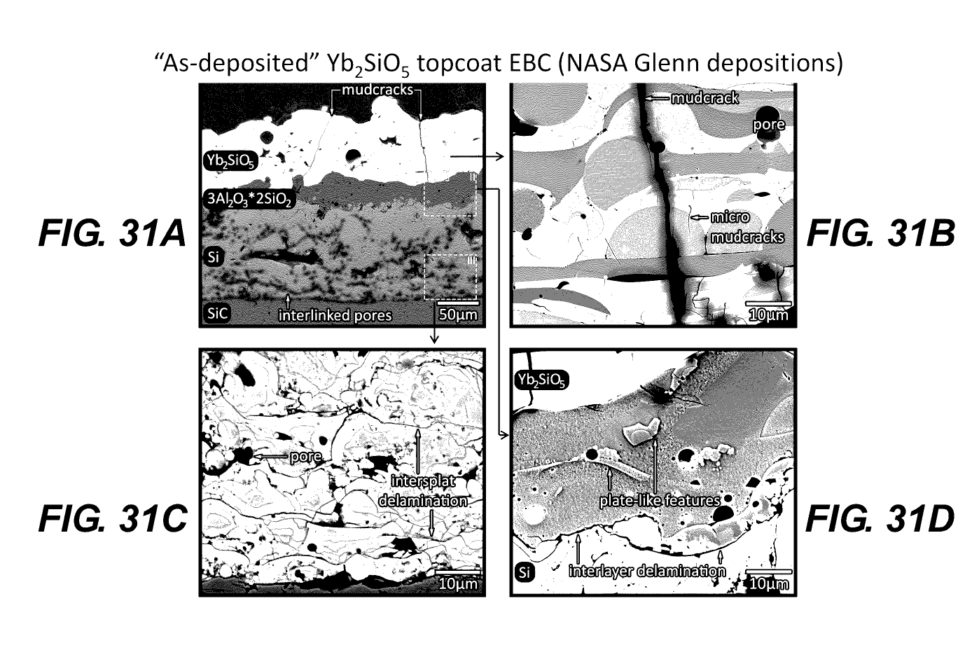

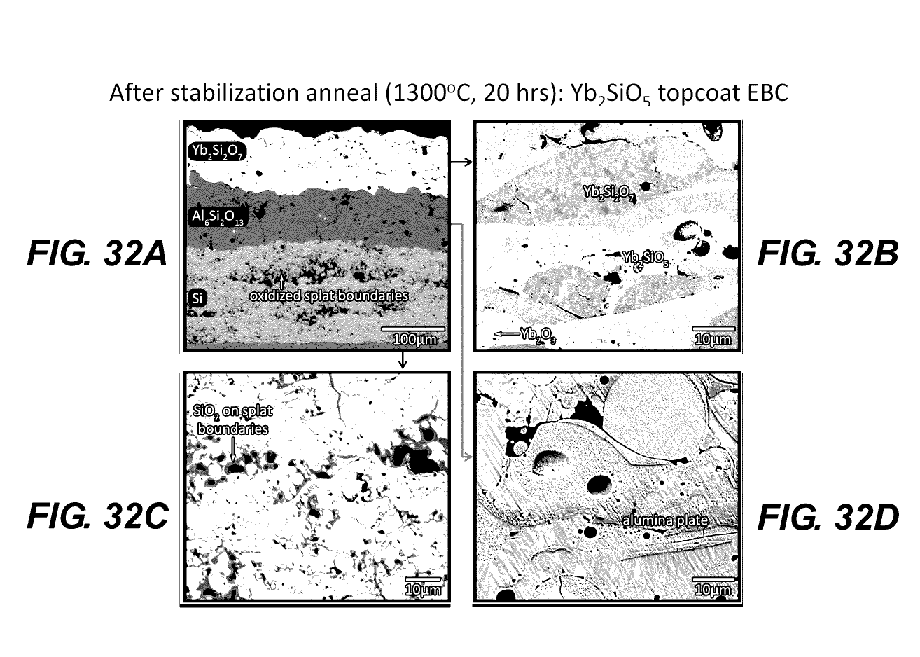

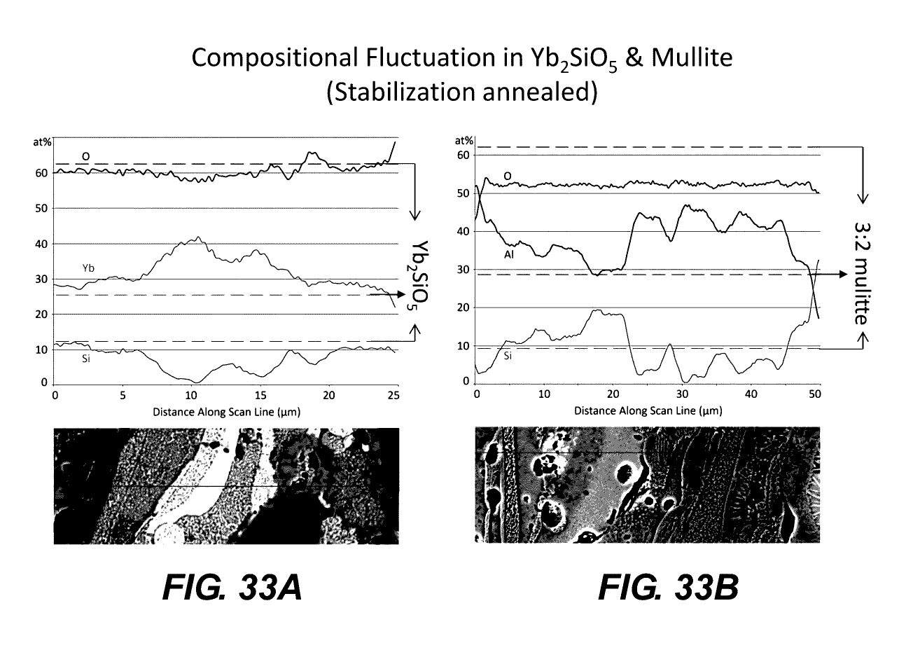

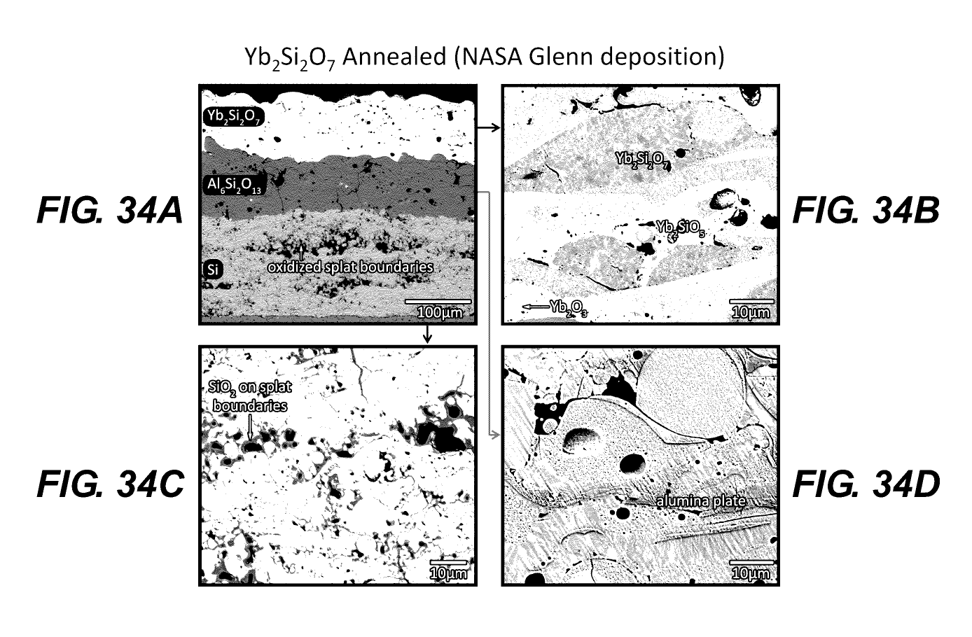

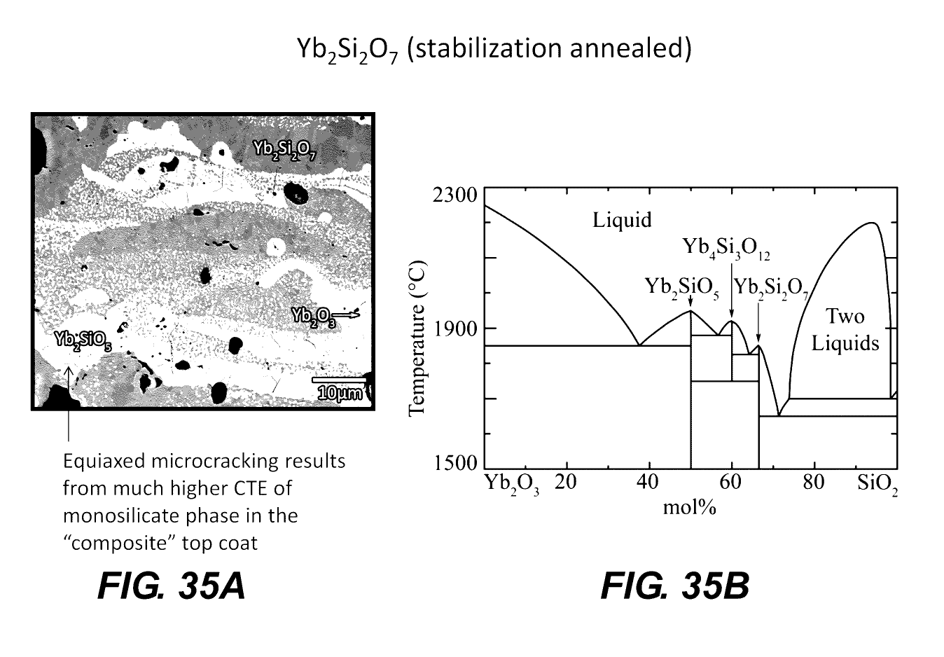

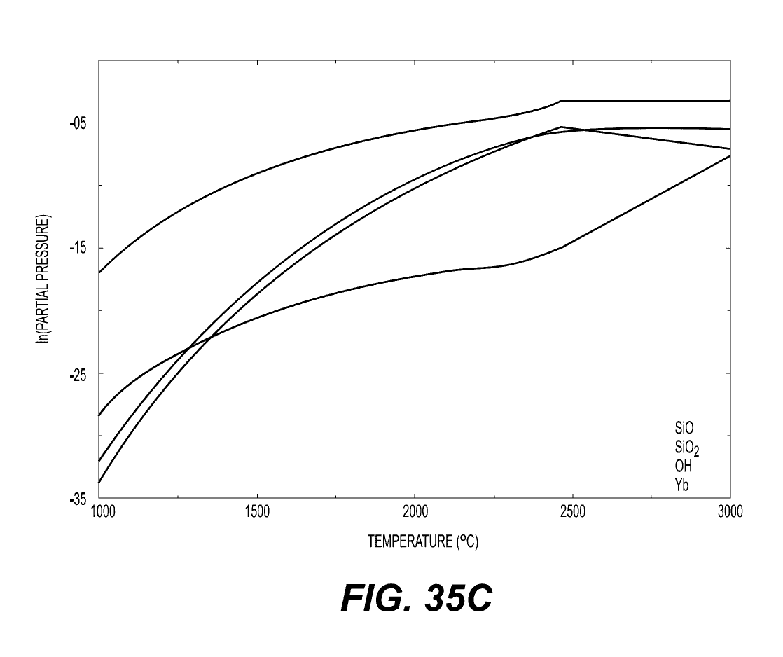

The cracking of the “as-deposited” YbSiO₅ topcoat EBC is shown in FIG. 31. The layer structure after stabilization annealing of the topcoat is shown in FIG. 32. The compositional fluctuation of the particular coating layers is shown in FIGS. 33A and 33B, 34, 35A-35C.

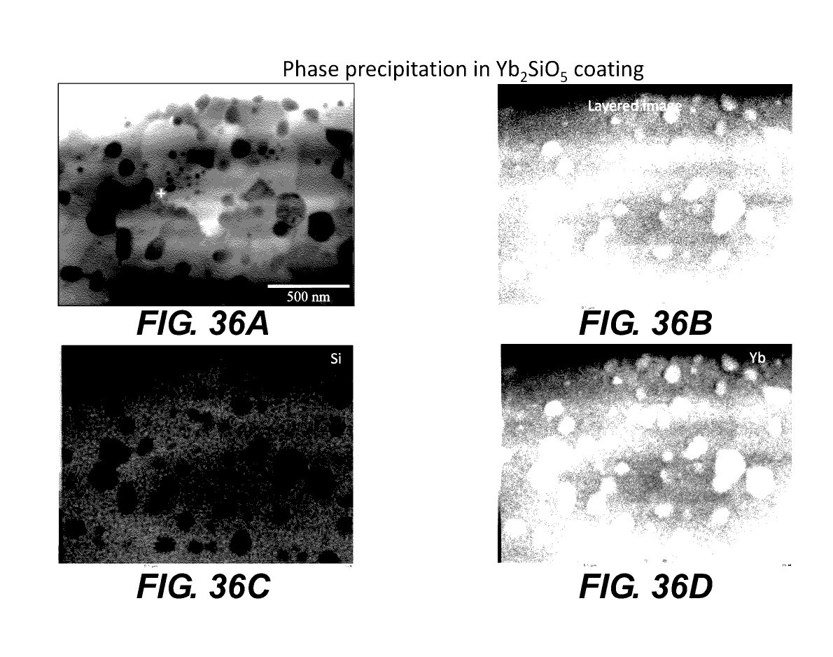

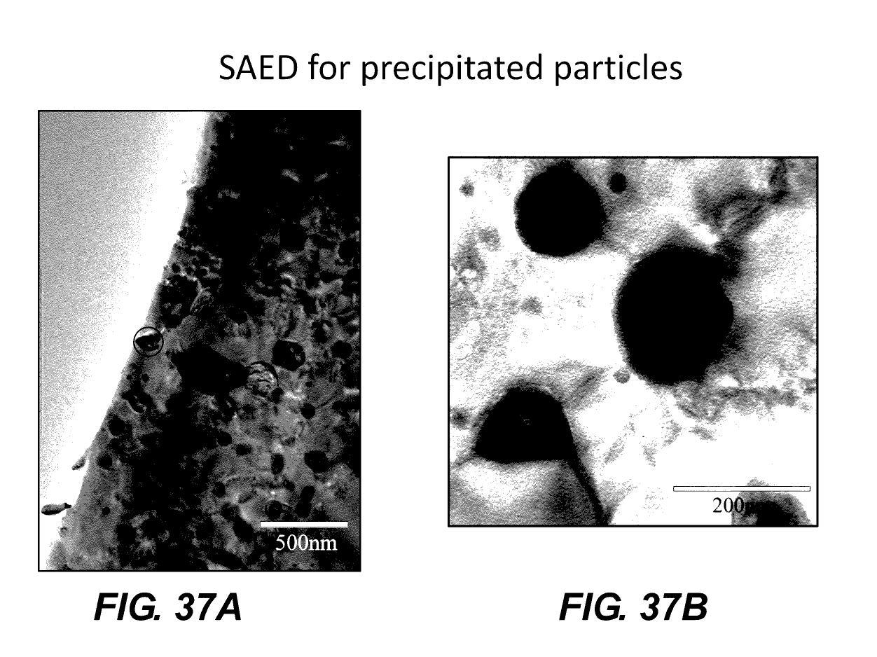

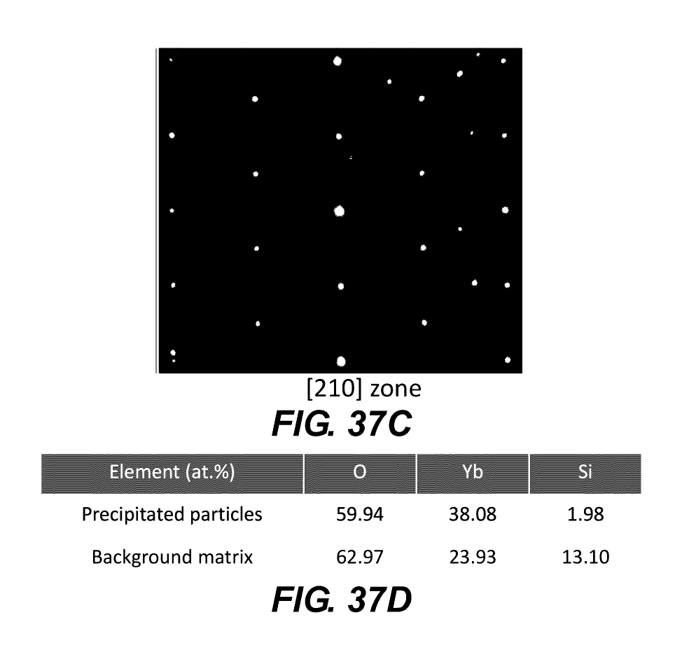

The phase precipitation in YbSiO₅ is shown in FIG. 36A-36D. The SAED for precipitated particles is shown in FIGS. 37A and 37B. The composition is shown in FIGS. 37C and 37D.

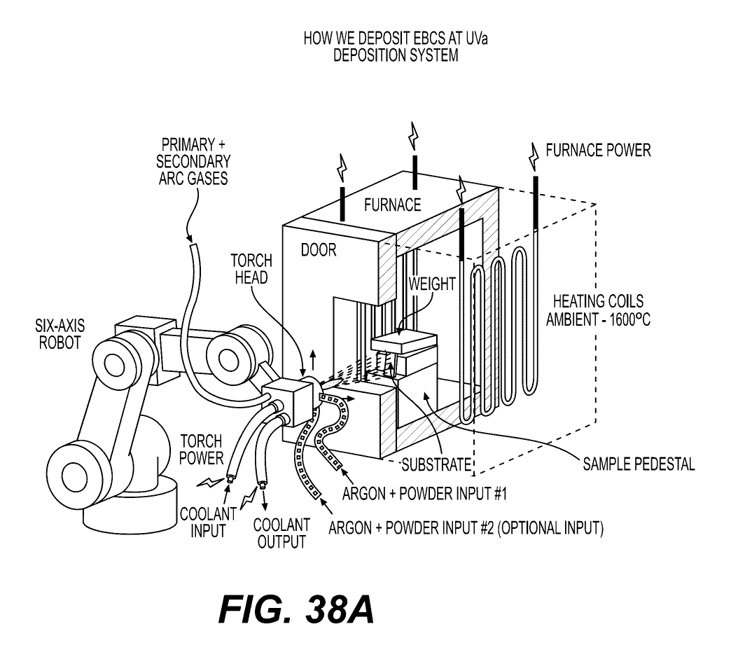

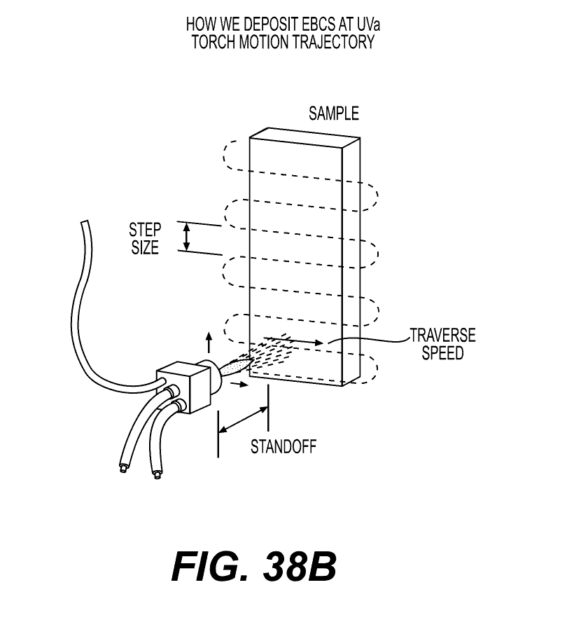

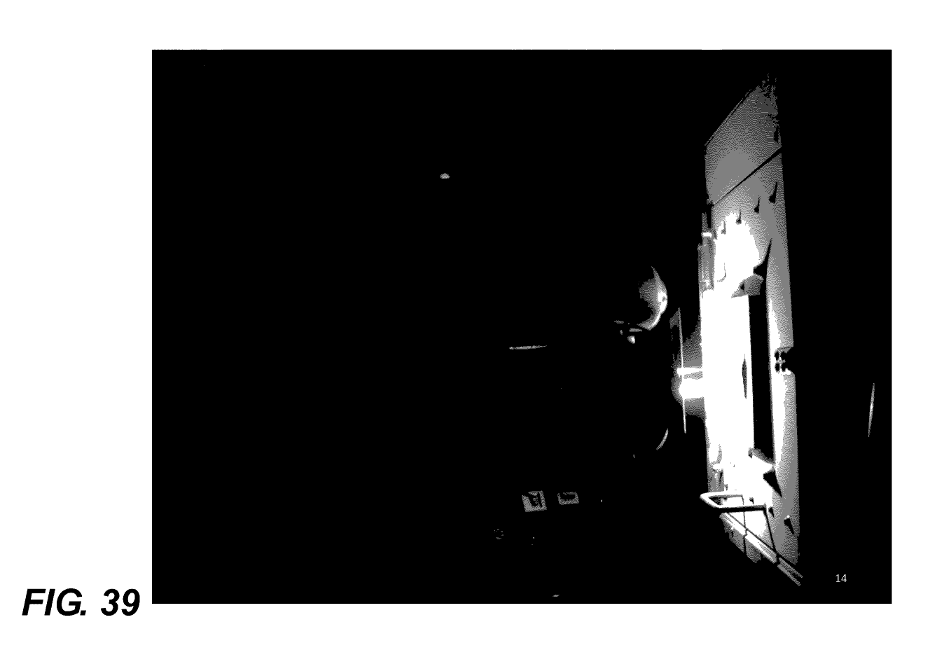

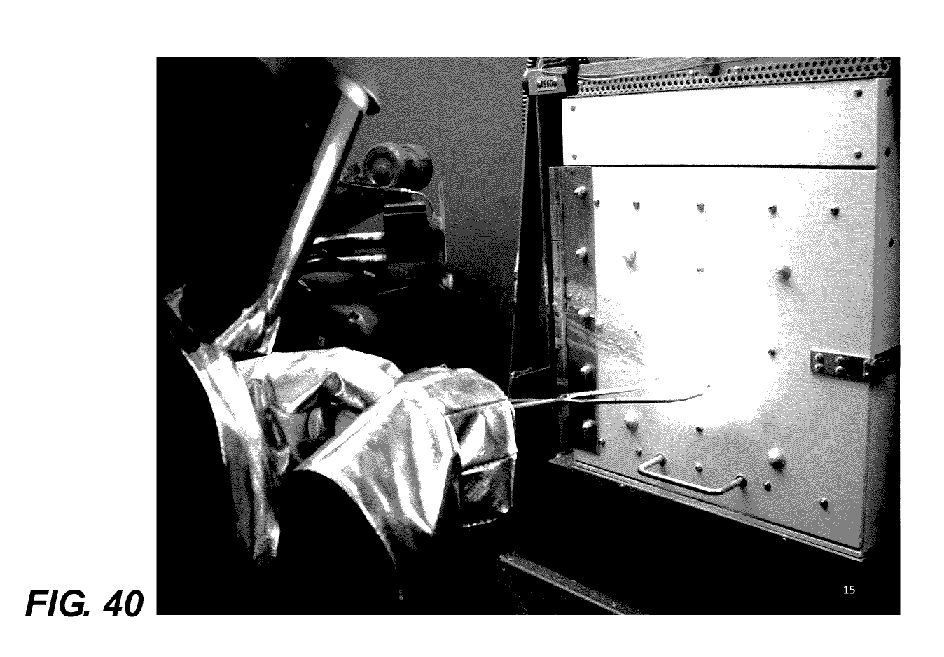

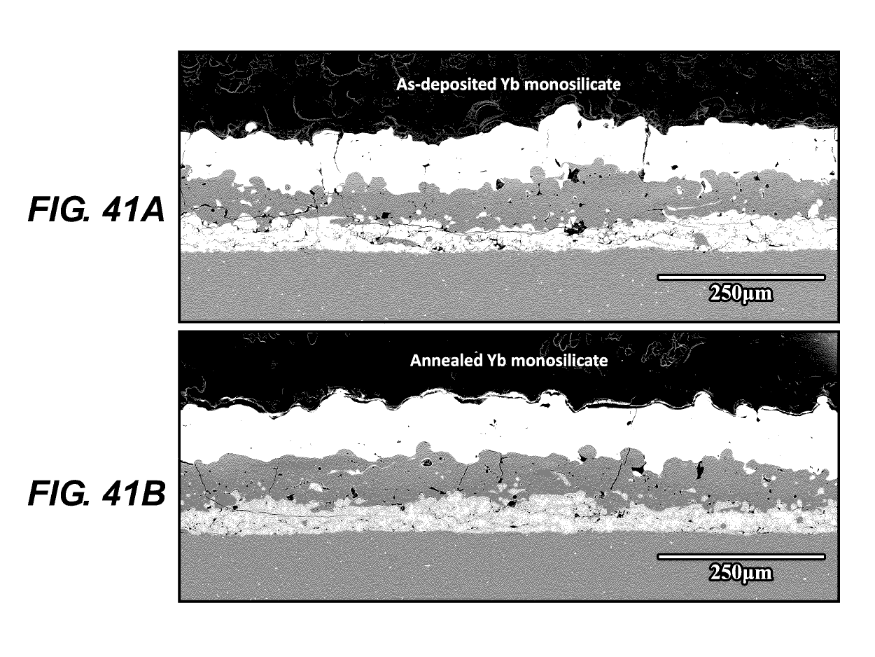

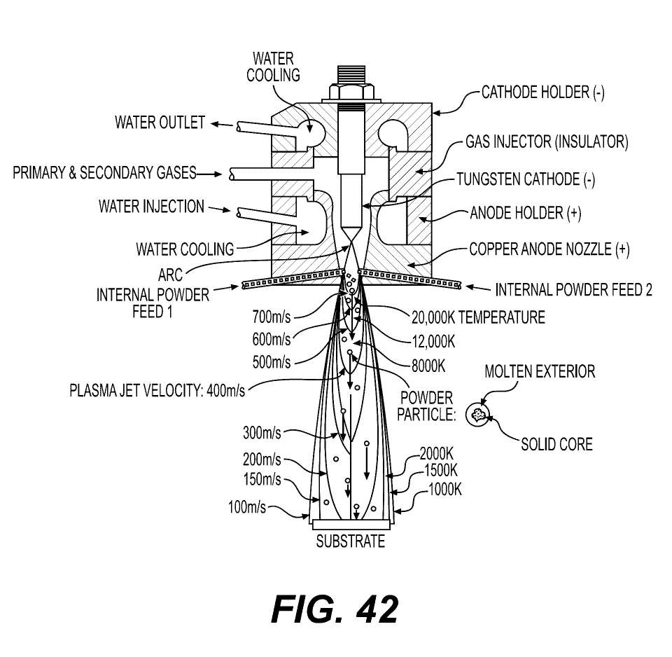

The deposition system for making the coating is shown in FIG. 38A. The torch motion trajectory is shown in FIG. 38B. The actual deposition system in operation is shown in FIGS. 39 and 40. The “as-deposited Yb monosilicate and the annealed Yb monosilicate is shown in FIG. 41. The details of the deposition system are shown in FIG. 42.

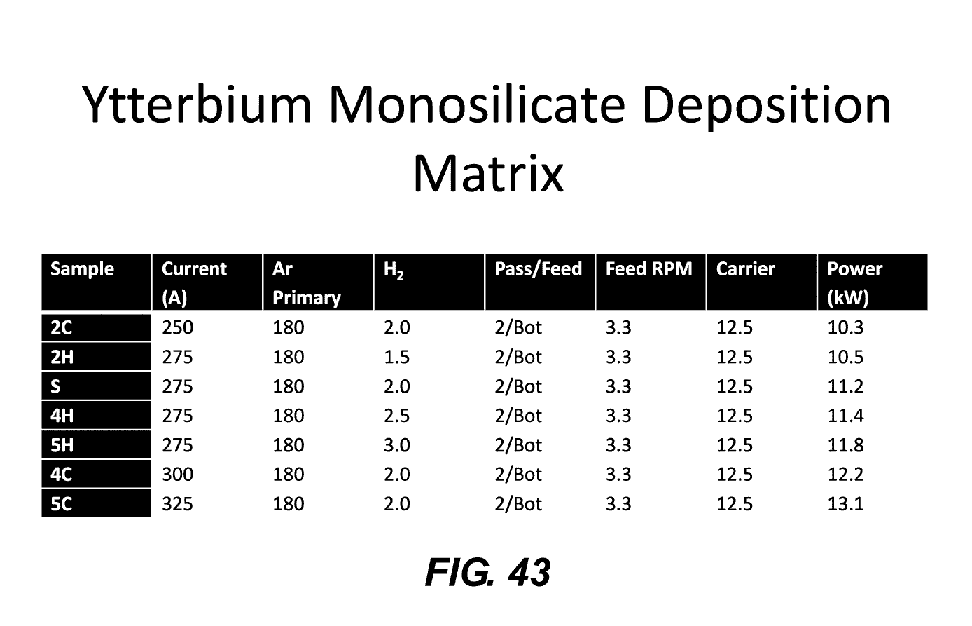

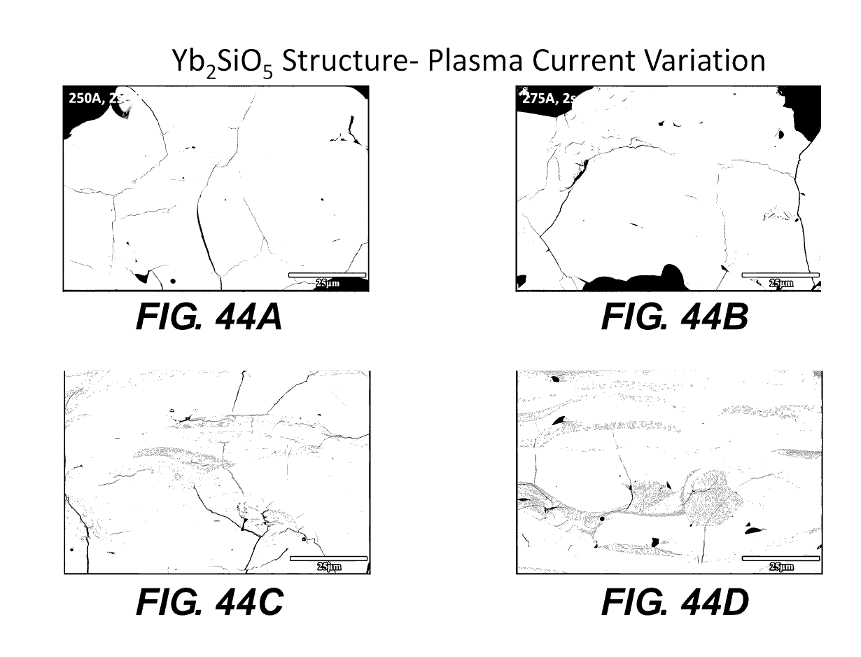

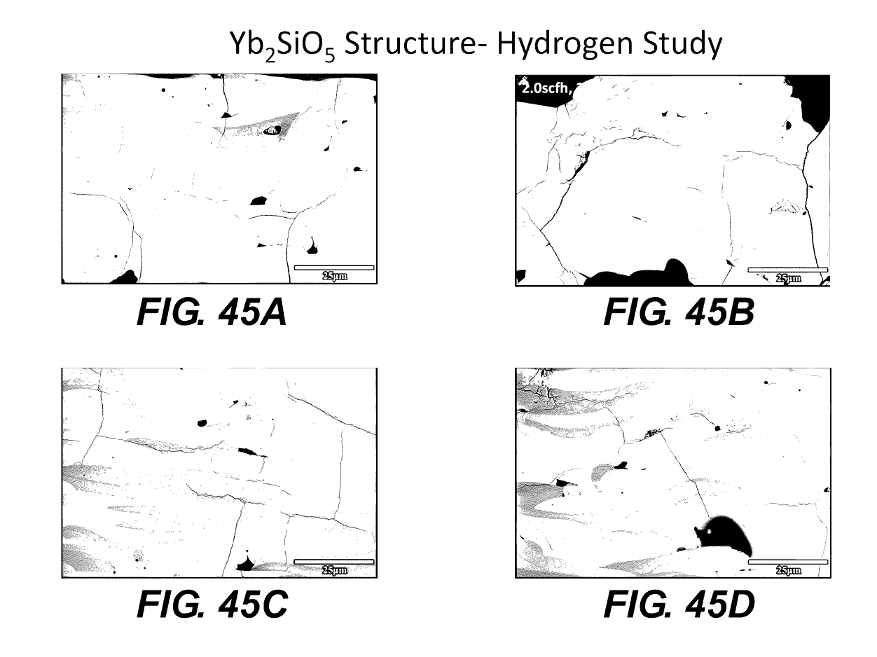

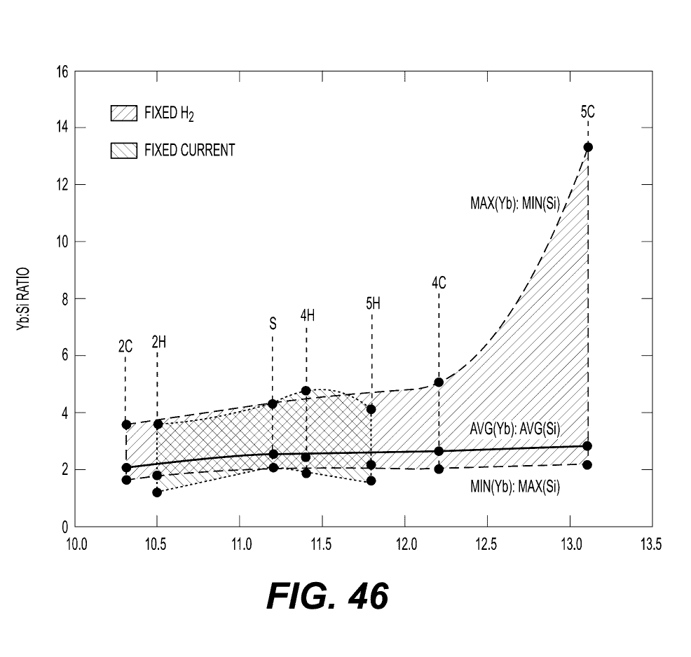

A Ytterbium monosilicate deposition matrix is shown in FIG. 43. The Ytterbium monosilicate structure—plasma current variation is shown in FIG. 44. The Ytterbium monosilicate structure—hydrogen study is shown in FIG. 45. A graph of the Yb:Si ratio is shown in FIG. 46.

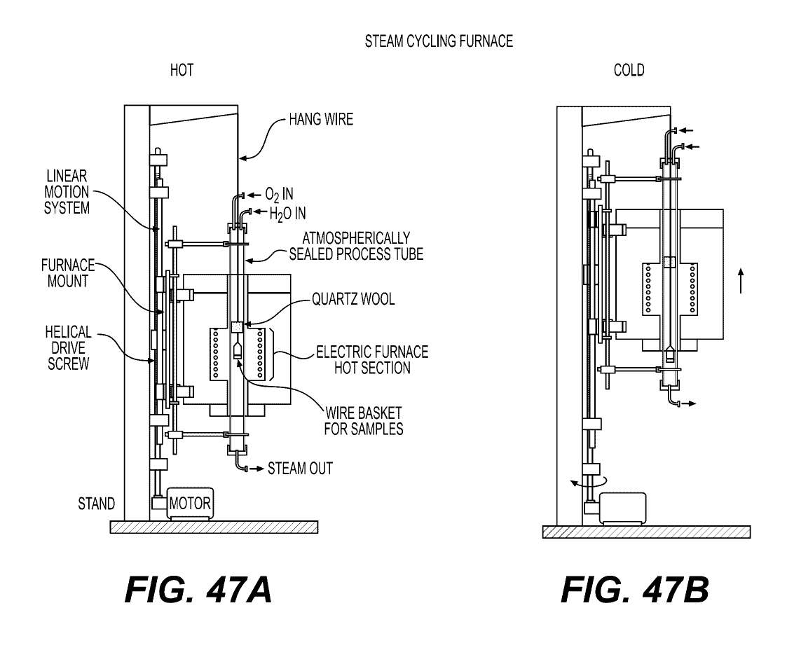

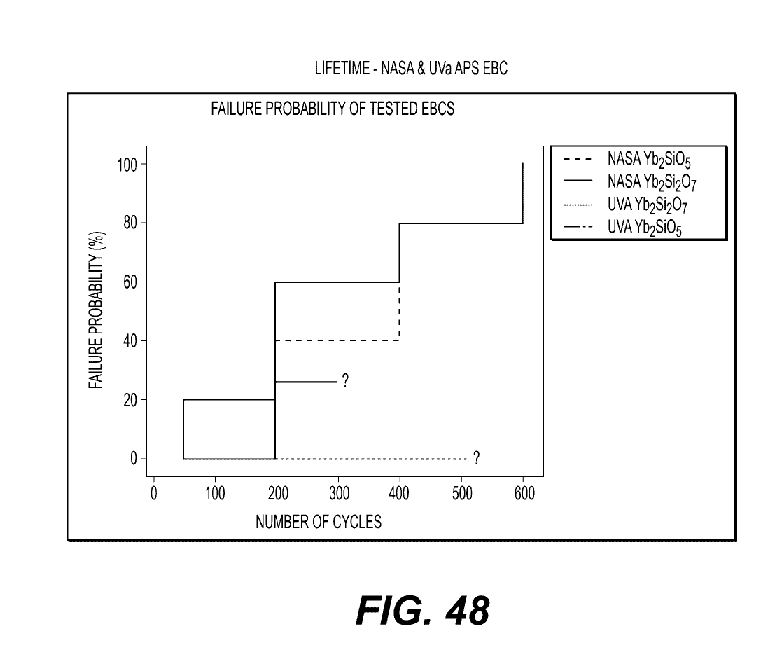

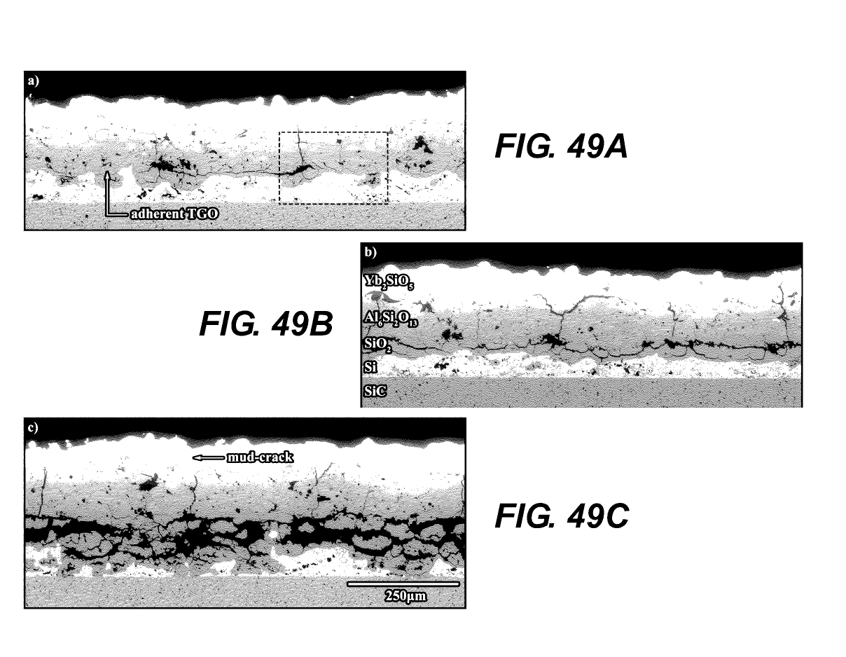

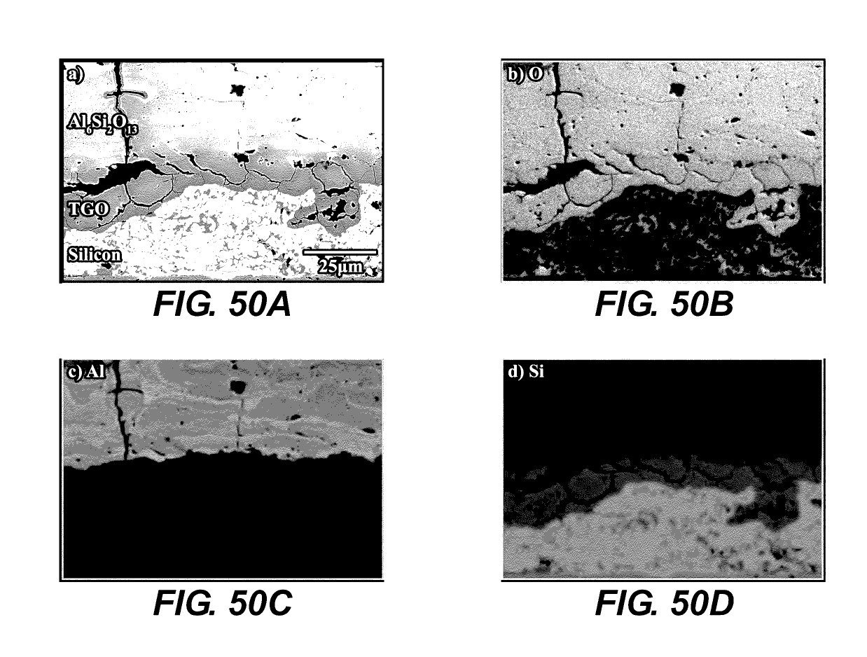

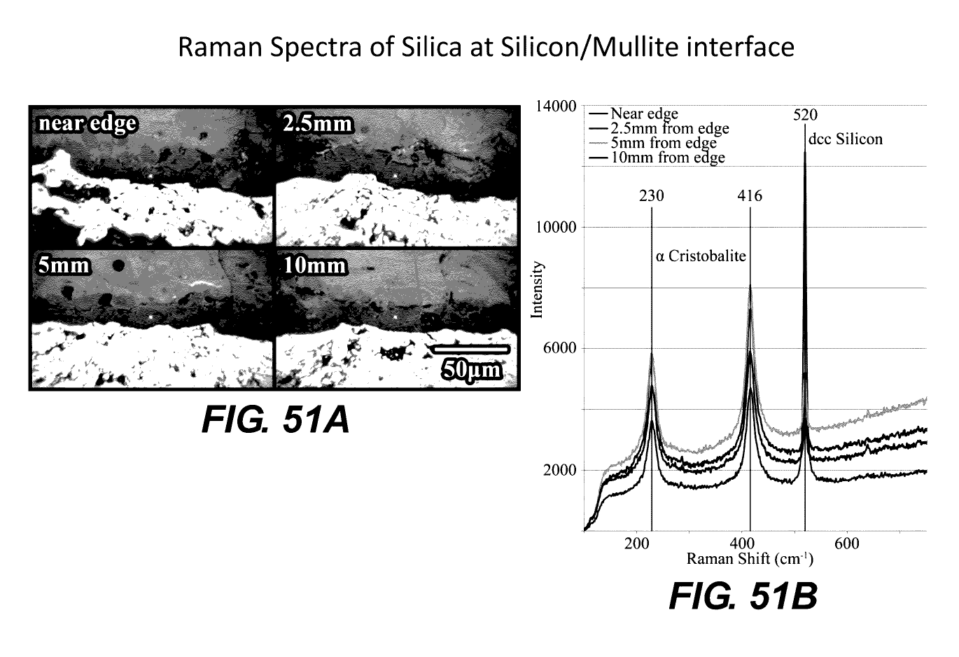

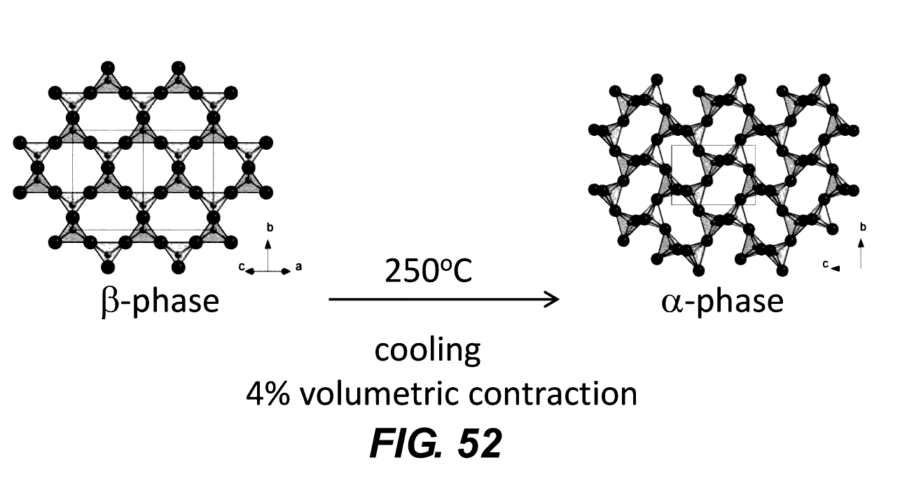

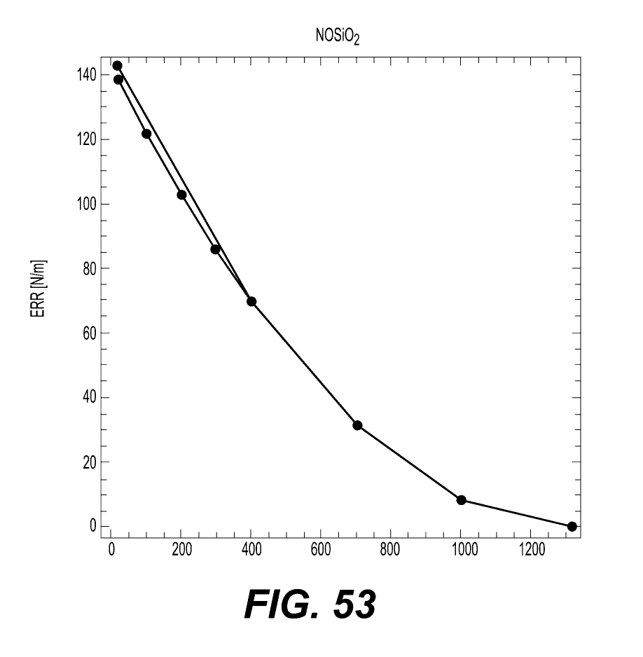

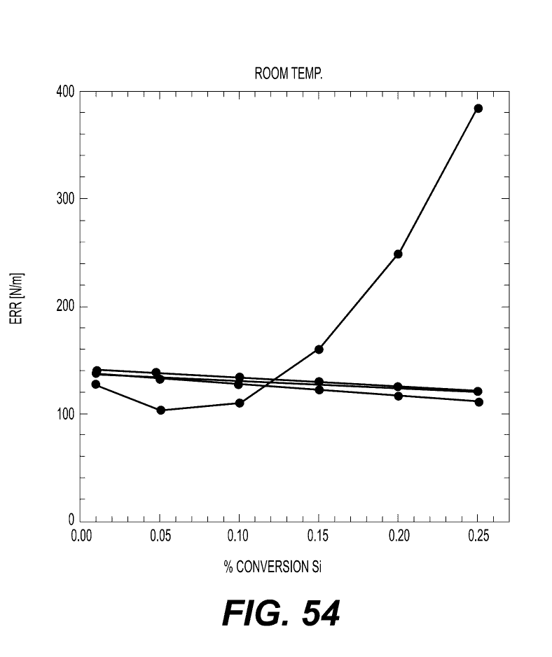

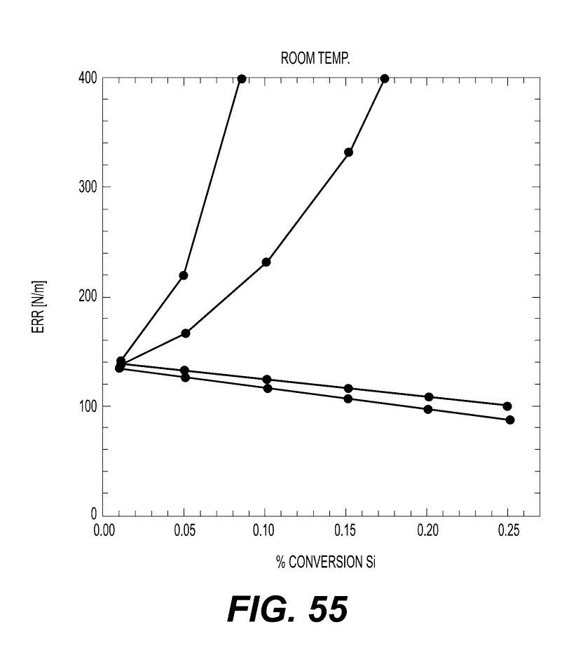

A steam cycling furnace is shown in FIGS. 47A and 47B. The failure probability graph is shown in FIG. 48. The details of cracking of the coating is shown in FIGS. 49A-49C and FIGS. 50A-50D. A Raman Spectra of silica at the silicone/mullite interface is shown in FIGS. 51A and 51B. The β-phase and α-phase are shown in FIG. 52. Graphs of the ERR verses % Conversion Si is shown in FIGS. 53, 54, and 55.

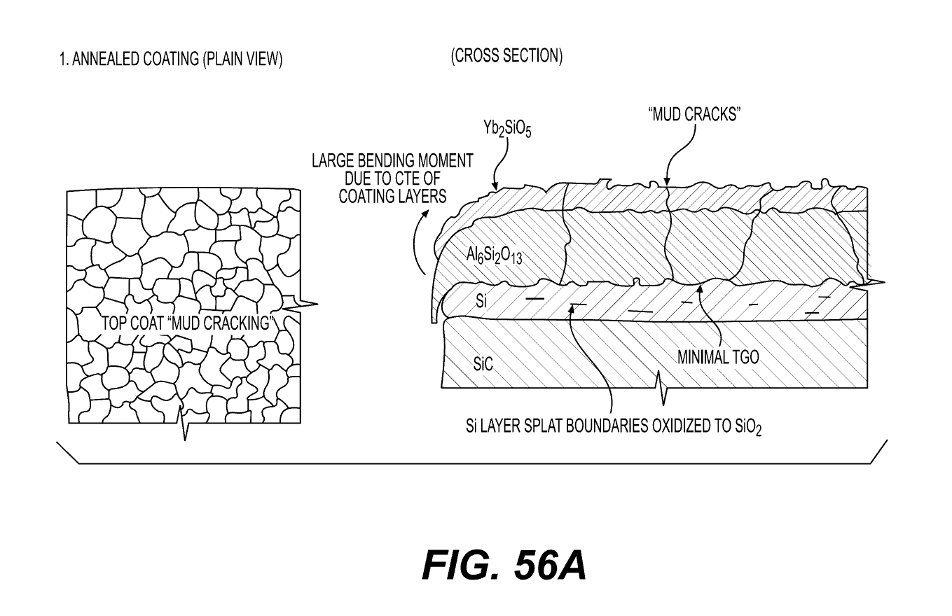

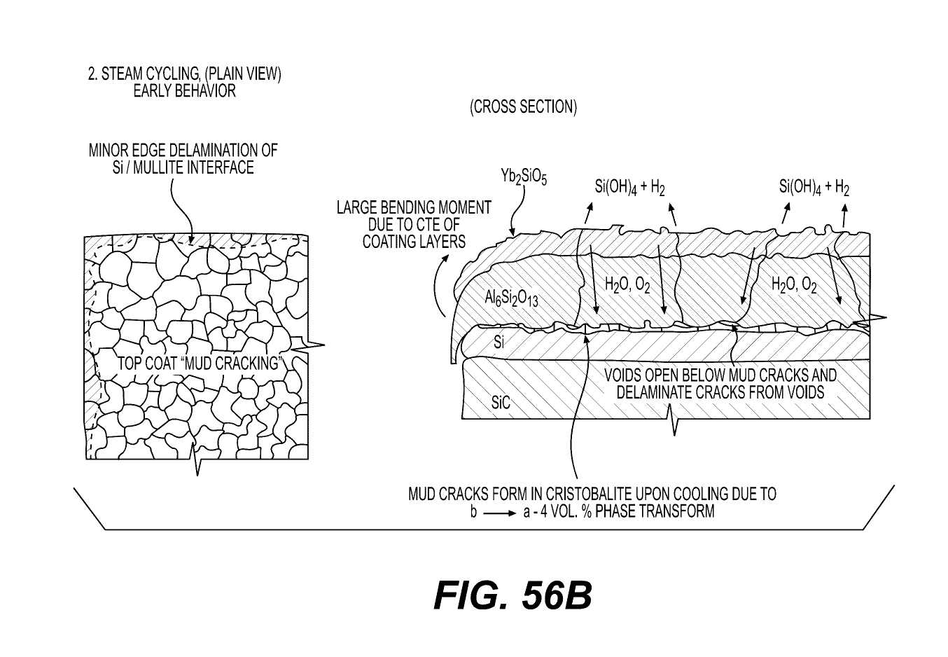

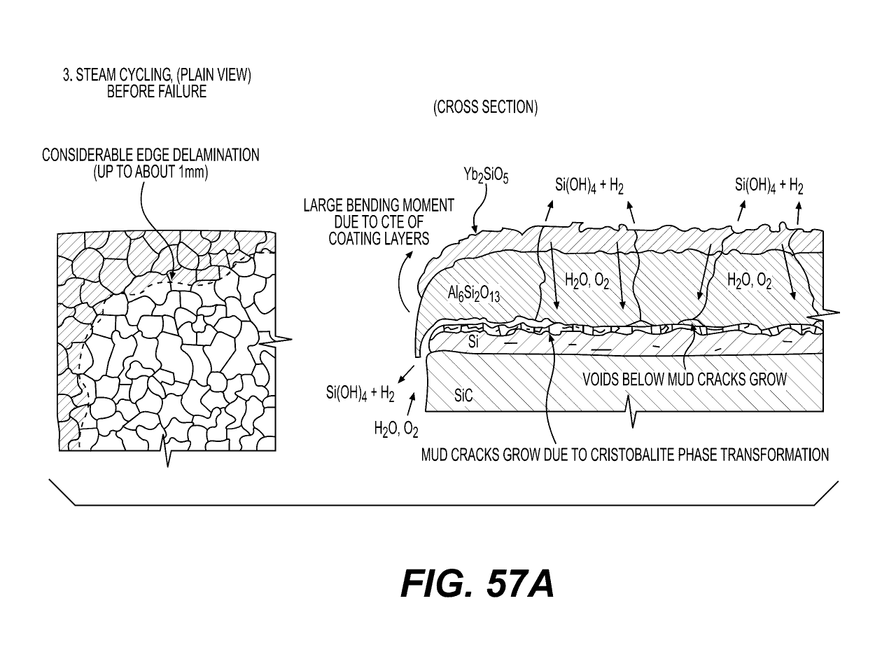

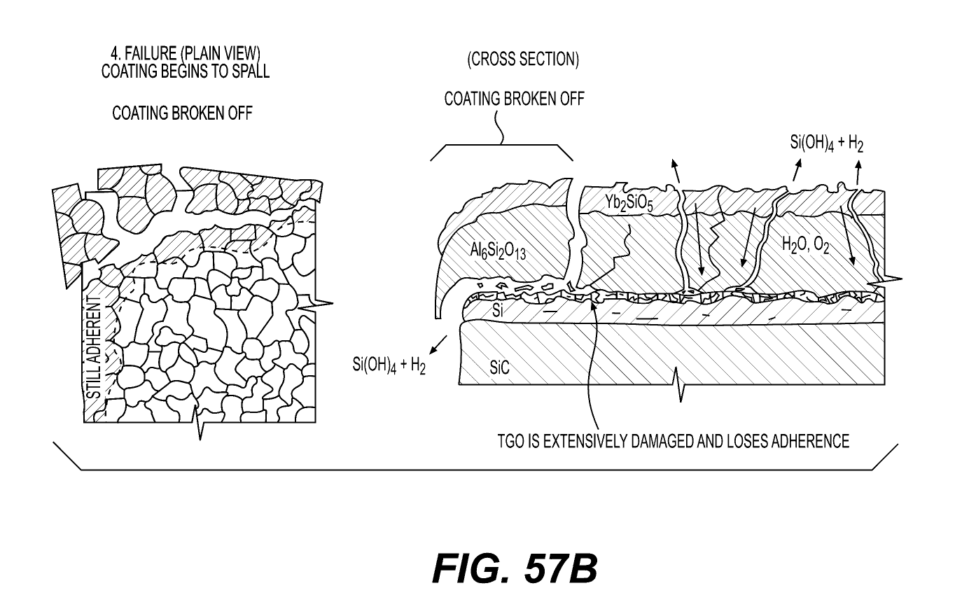

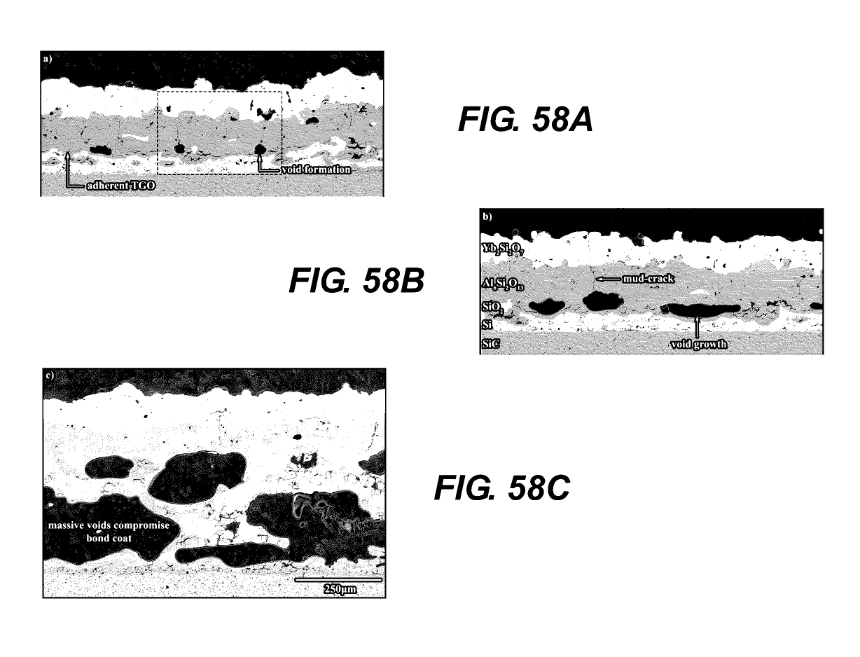

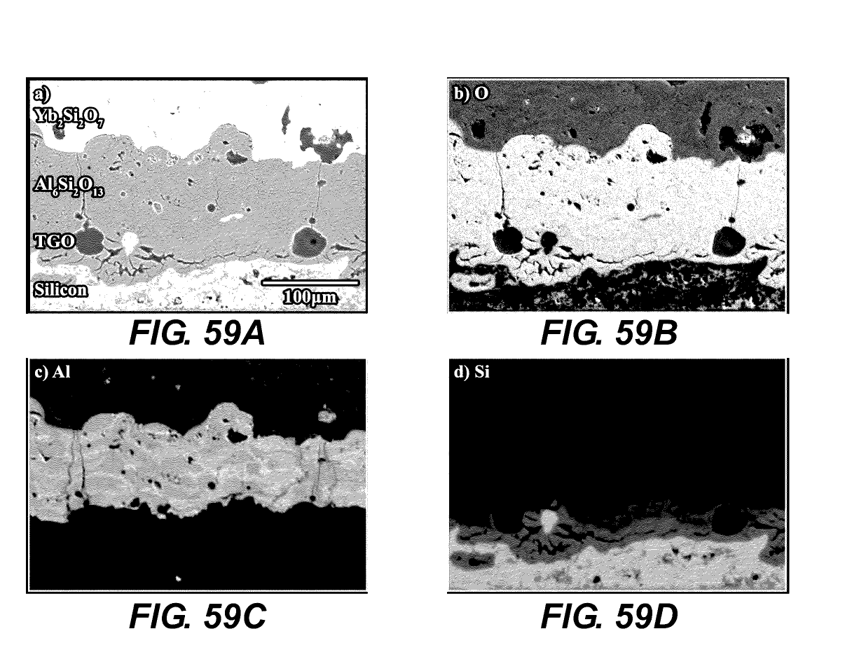

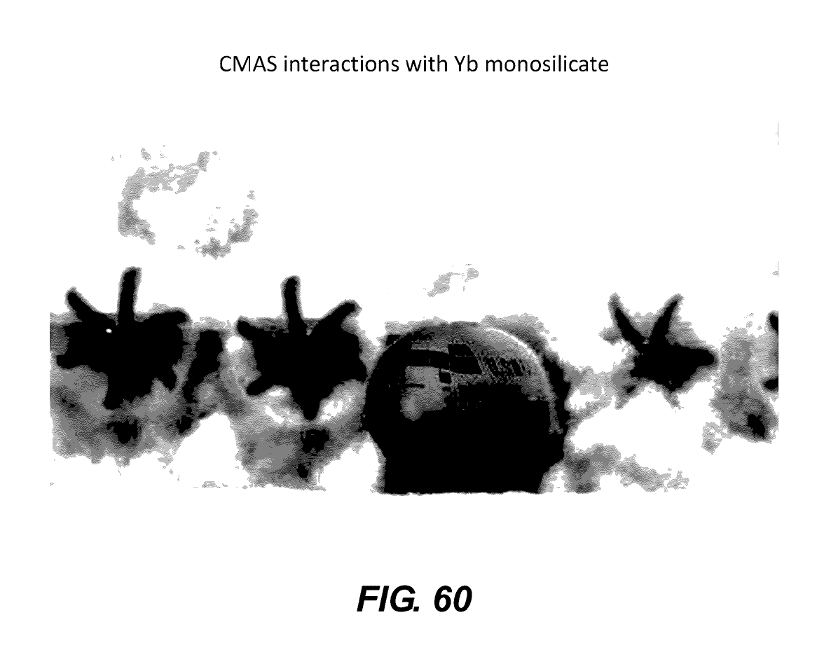

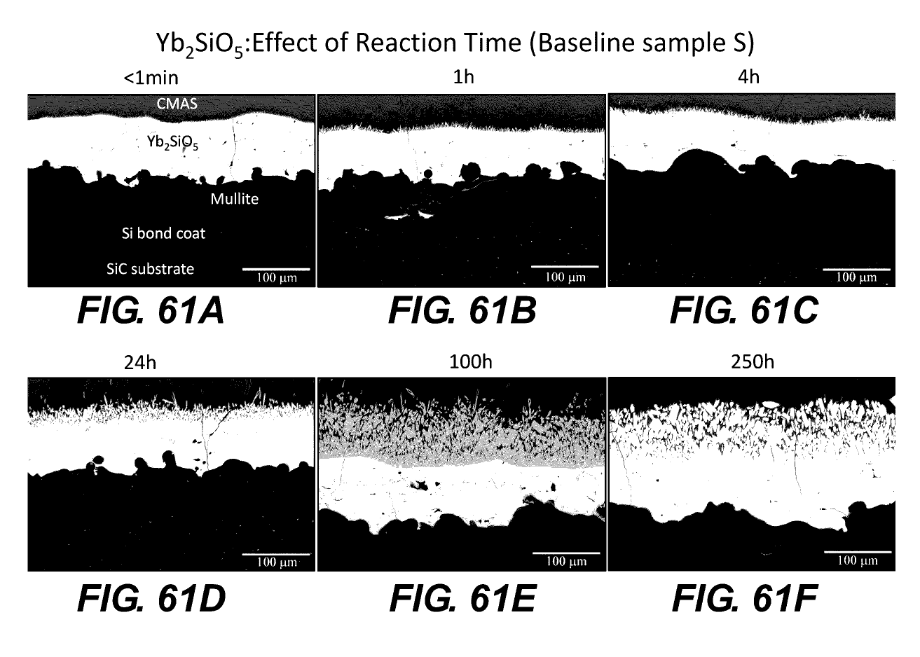

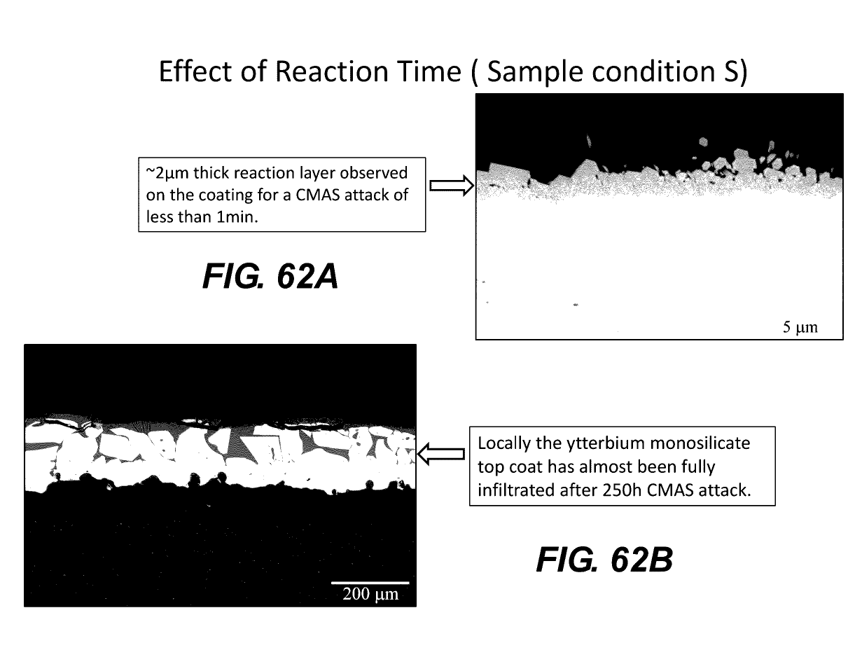

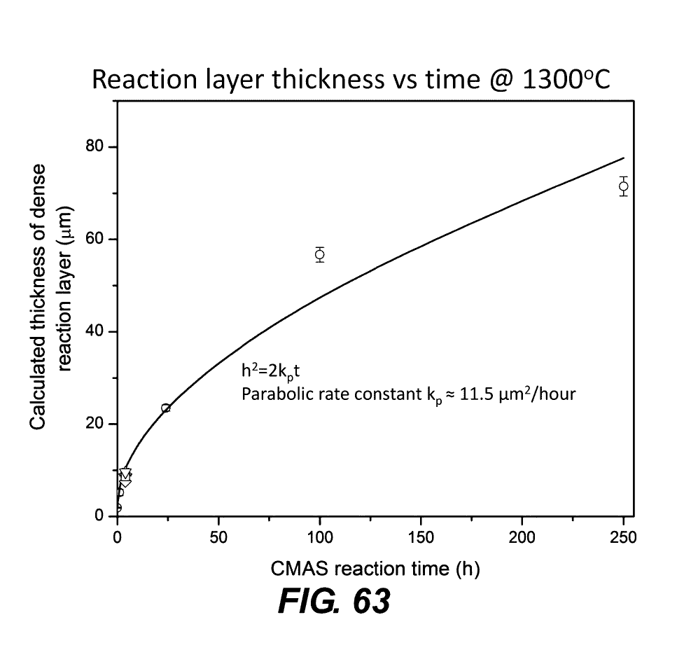

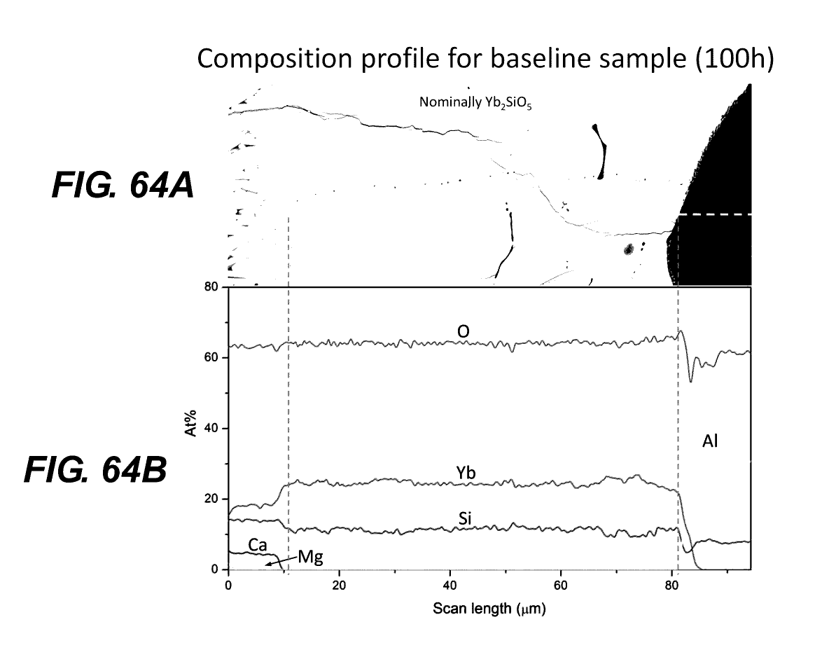

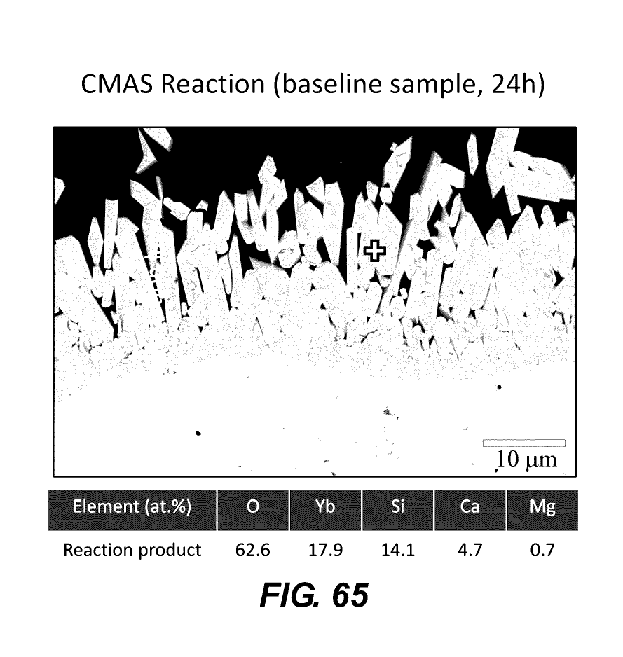

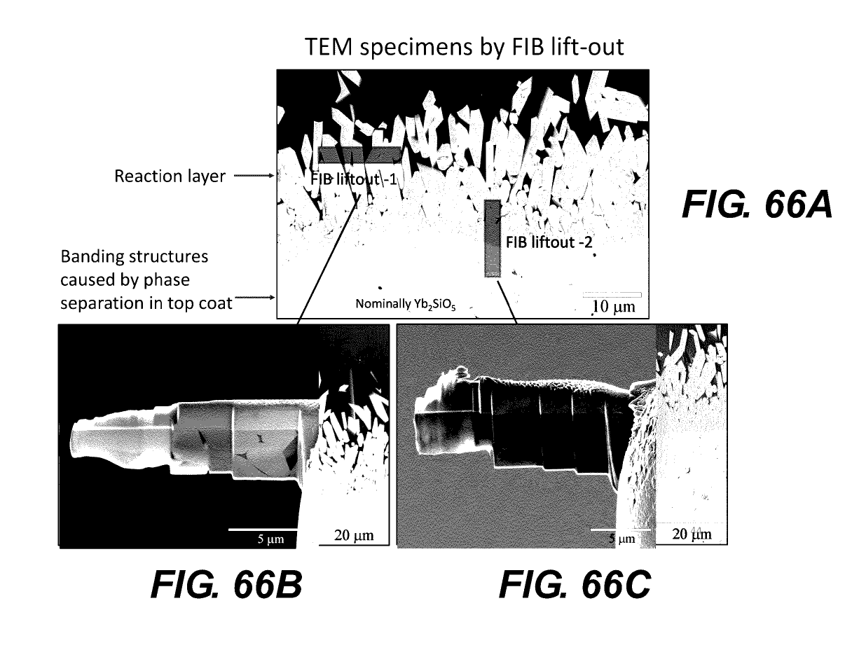

The structure of the annealed coating is shown in FIG. 56A. The steam cycling early behavior is shown in FIG. 56B. The steam cycling before failure is shown in FIG. 57A. The steam cycling upon failure is shown in FIG. 57B. The details are shown in FIGS. 58A-58C and 59A-59D. The CMAS interactions with Yb monosilicate is shown in FIG. 60. The effect of reaction time is shown in FIGS. 61A-61F and FIGS. 62A and 62B. A table of Reaction layer thickness verses time is shown in FIG. 63. The composition profile for baseline sample is shown in FIG. 64. The CMAS Reaction is shown in FIG. 65. The TEM specimens are shown in FIG. 66.

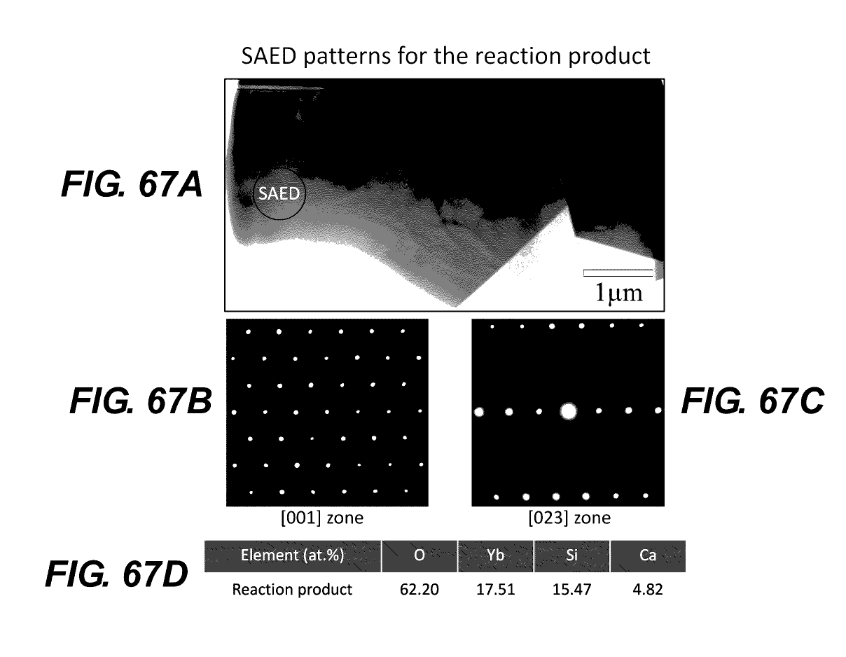

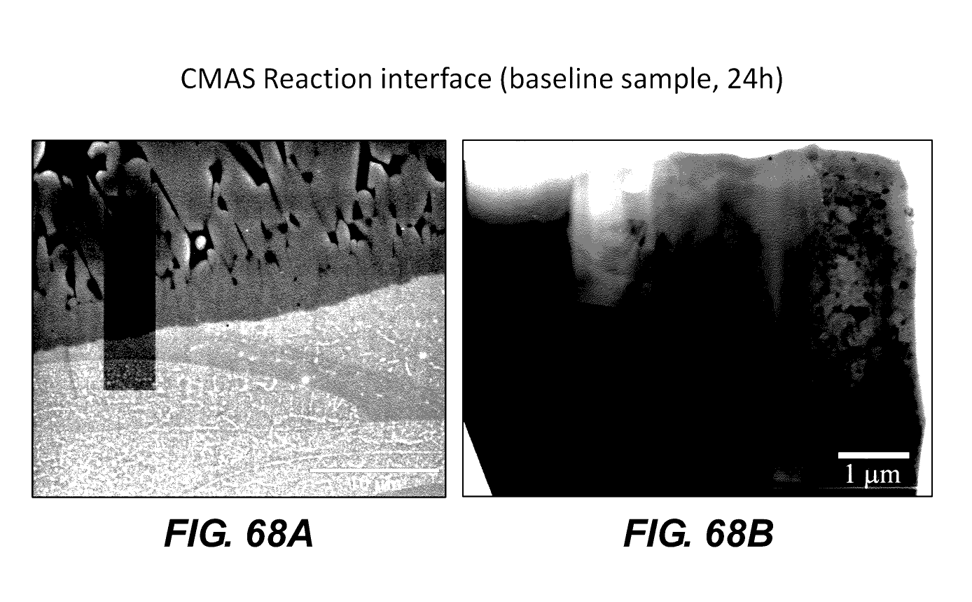

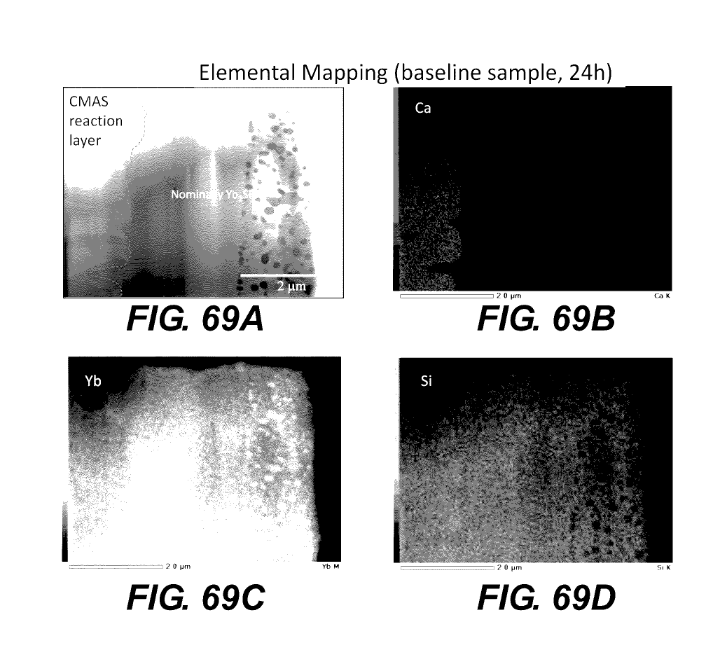

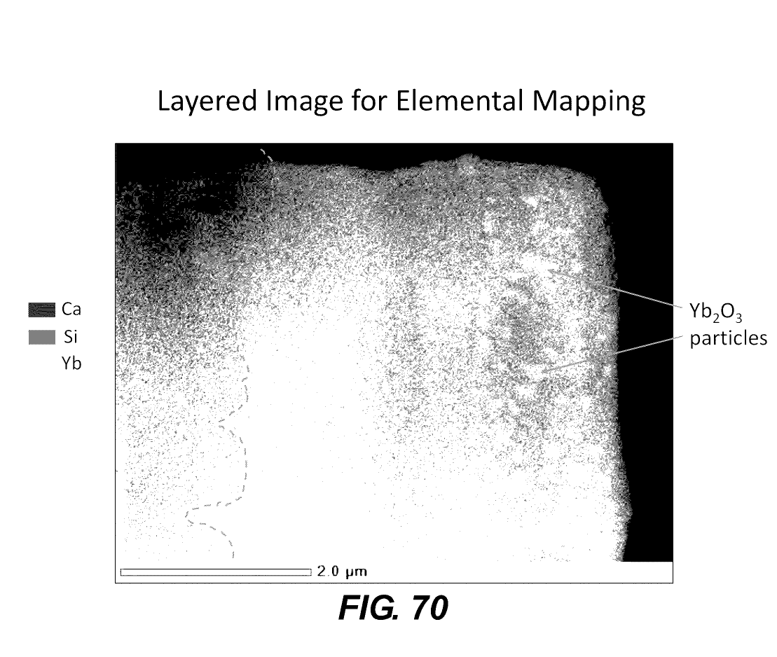

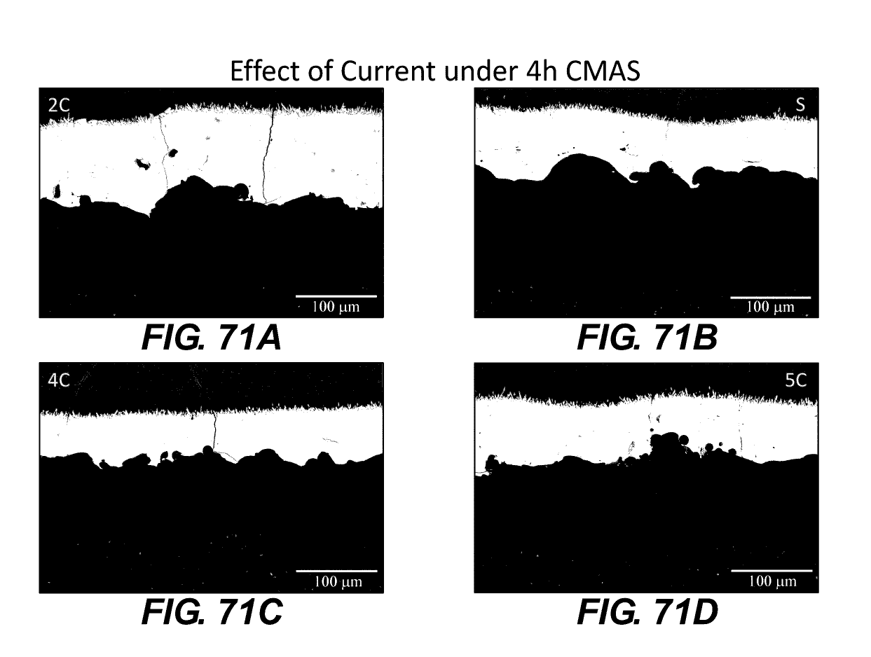

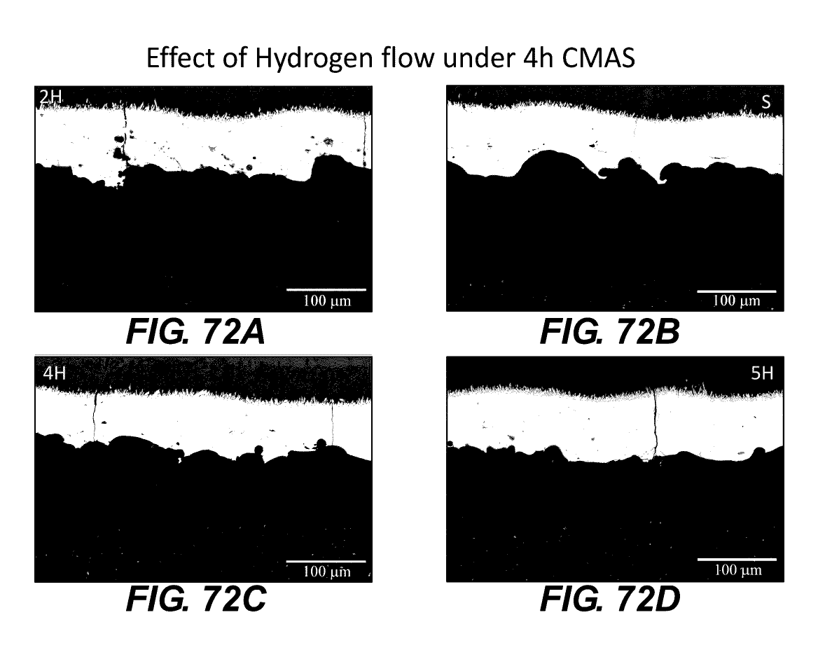

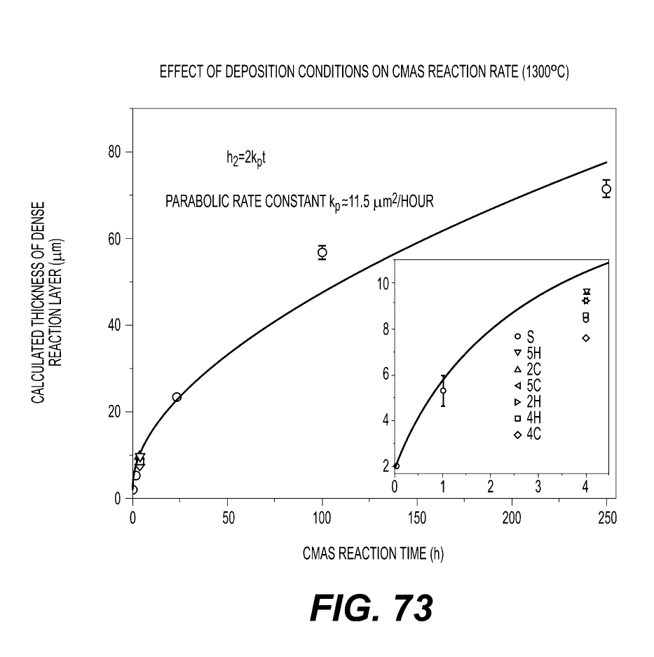

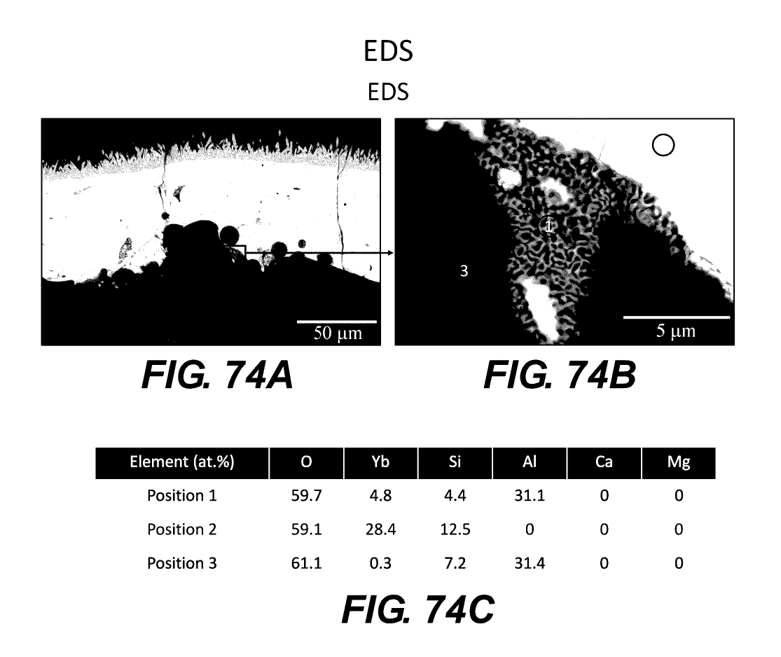

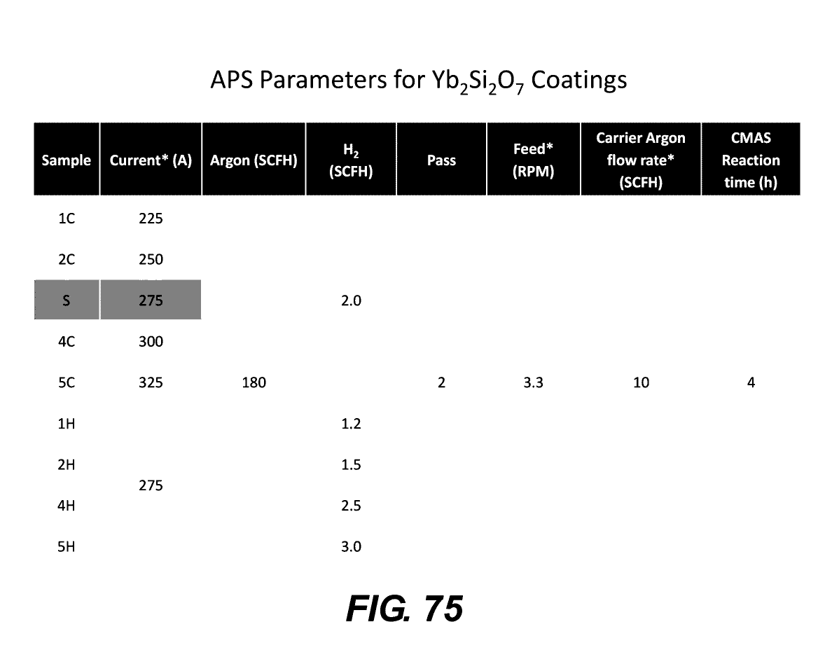

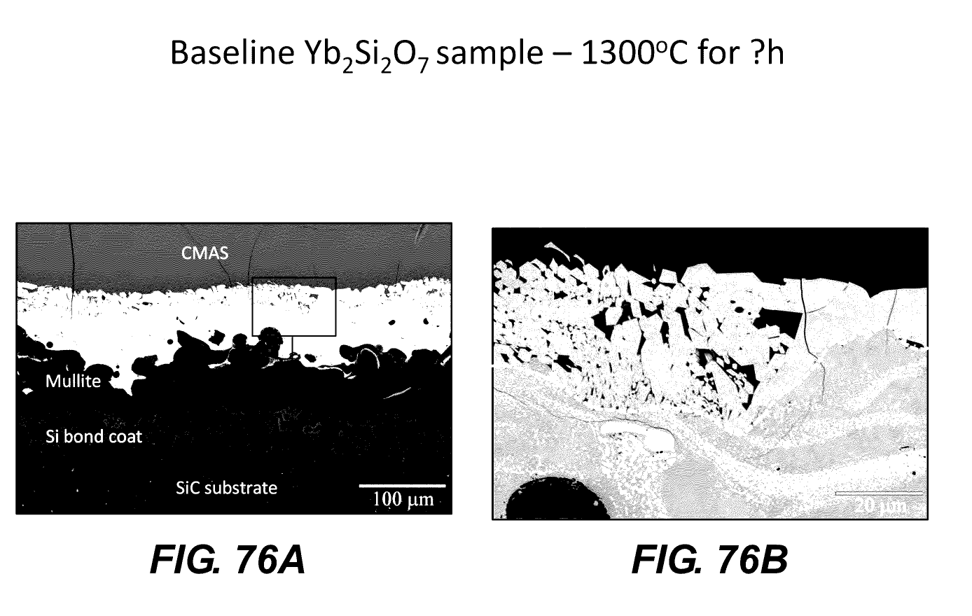

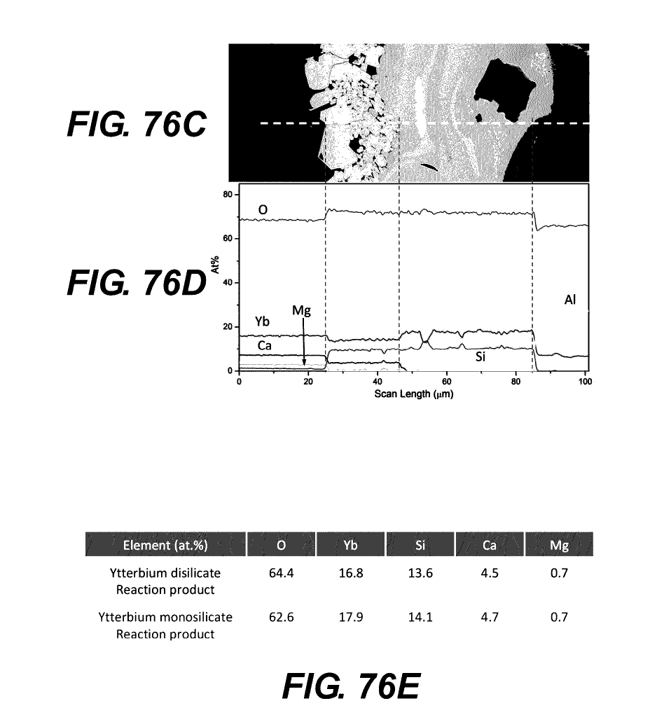

The SAED patterns for the reaction product are shown in FIG. 67. The CMAS Reaction interface is shown in FIGS. 68A and 68B. The elemental mapping is shown in FIG. 69. The layered image for elemental mapping is shown in FIG. 70. The effect of current is shown in FIGS. 71A-71D. The effect of hydrogen flow is shown in FIGS. 72A-72D. A graph of the effect of deposition conditions on CMAS reaction rate is shown in FIG. 73. The EDS is shown in FIG. 74. The APS Parameters for Yb disilicate is shown in FIG. 75. The Baseline Yb disilicate is shown in FIGS. 76A and 76B. A graph of At % verses Scan Length is shown in FIG. 76C.

1. An air plasma method for the deposition of an advanced EBC coating system, comprising
applying a silicone bond coat to a SiC substrate;
exposing the silicone bond coat to oxygen to form a proactive SiO₂ thermally grown oxide (TGO) layer to avoid decomposition of the SiC substrate to SiO₂ and gaseous CO;
applying a layer of mullite over the silicon bond coat to impede diffusion of oxygen to the silicon bond coat; and
applying a ytterbium disilicate topcoat over the layer of mullite, the ytterbium disilicate having a very low silica volatility and protecting the layer of mullite and silicon layer from volatilization by water vapor.

2. The method according to claim 1, wherein the silicon bond coat is applied directly to the SiC substrate.

3. The method according to claim 1, wherein the ytterbium disilicate topcoat is applied directly to the silicon bond coat.

4. The method according to claim 1, wherein the ytterbium disilcate topcoat is applied as a two layer coating system.

5. The method according to claim 4, wherein a first layer of the two layer coating system is deposited on the silicone bond coat at 1200° C. in a reducing (Ar/H2) atmosphere.

6. The method according to claim 5, wherein the first layer is 50 μm thick.

7. The method according to claim 5, wherein the first layer has a porosity of about 5%.

8. The method according to claim 5, wherein a second layer of the two layer coating system is deposited on the first layer at 1200° C., without a protective reducing gas atmosphere.

9. The method according to claim 1, wherein a surface of the SiC substrate is roughened before applying the silicone bond coat to the surface of the SiC substrate

10. An EBC coating system comprising:
a SiC substrate;
a silicon bond coat applied directly to the SiC substrate;
a proactive SiO₂ thermally grown oxide (TGO) layer applied over the silicone bond coat;
a layer of mullite applied over the silicon bond coat; and
a ytterbium disilicate topcoat applied over the layer of mullite.

11. The system according to claim 10, wherein the silicon bond coat is applied directly to the SiC substrate.

12. The system according to claim 1, wherein the ytterbium disilicate topcoat is applied directly to the silicon bond coat.

13. The system according to claim 1, wherein the ytterbium disilcate topcoat is applied as a two layer coating system.

14. The system according to claim 13, wherein a first layer of the two layer coating system is deposited on the silicone bond coat at 1200° C. in a reducing (Ar/H2) atmosphere.

15. The system according to claim 14, wherein the first layer is 50 μm thick.

16. The system according to claim 14, wherein the first layer has a porosity of about 5%.

17. The system according to claim 14, wherein a second layer of the two layer coating system is deposited on the first layer at 1200° C., without a protective reducing gas atmosphere.

18. The system according to claim 10, wherein a surface of the SiC substrate is roughened before applying the silicone bond coat to the surface of the SiC substrate.
